(19) United States
(12) Patent Application Publication
(10) Pub. No.: US 2026/0152078 A1
(43) Pub. Date: Jun. 4, 2026

(54) DISCHARGE POWER ALLOCATION ON ELECTRIC POWER MACHINE

(71) Applicant: Doosan Bobcat North America, Inc., West Fargo, ND (US)

(72) Inventors: Preston Schatz, Bismarck, ND (US); Dexter Jenson, Moorhead, MN (US); Vojtech Straskraba, Dobris (CZ); Petr Abrham, Horovice (CZ); Tomas Vostrel, Cernosice (CZ); Martin Uzel, Obecnice (CZ); Benoit Monot, Arradon (FR)

(21) Appl. No.: 19/406,604

(22) Filed: Dec. 2, 2025

Related U.S. Application Data
(60) Provisional application No. 63/727,060, filed on Dec. 2, 2024.

(51) Int. Cl. B60L 50/60; B60L 15/20; B60L 58/12

(52) U.S. Cl. CPC B60L 50/60; B60L 15/2045; B60L 58/12; B60L 2200/40; B60L 2240/421; B60L 2240/423; B60L 2240/425; B60L 2240/525; B60L 2240/549

(57) ABSTRACT

Disclosed are power machines having an electric power source which powers a priority system and a non-priority system. A control system determines from a discharge current limit of a battery of the electric power source a priority reserve of discharge current for the priority system, a non-priority reserve of discharge current for the non-priority system, and a pool of discharge current separate from the priority reserve and non-priority reserve. The control system controls the allocation of discharge current to the priority system and to the non-priority system as a function of the priority reserve, the non-priority reserve, and the pool. A control system also determines an inverter temperature scalar, a motor temperature scalar, and a discharge current scalar. Using these scalars, the control system determines a power management scalar which is used to derate power usage by a system such as the priority system.

### CROSS-REFERENCE TO RELATED APPLICATIONS

This application claims the benefit of U.S. provisional application No. 63/727,060, filed 2 Dec. 2024, which is hereby incorporated by reference in its entirety as though fully set forth herein.

### BACKGROUND

The present disclosure relates to electric power machines. More specifically, the present disclosure relates to electric power machines having control systems configured to control discharge power allocation to priority and non-priority systems.

Power machines, for the purposes of this disclosure, include any type of machine that generates power for the purpose of accomplishing a particular task or a variety of tasks. One type of power machine is a work vehicle. Work vehicles are generally self-propelled vehicles that have a work device, such as a lift arm (although some work vehicles can have other work devices such as a mower deck) that can be manipulated to perform a work function. Work vehicles include zero-turn radius (ZTR) mowers, loaders, excavators, utility vehicles, telehandlers, tractors, and trenchers, to name a few examples. The work device on some power machines, such as power machines with lift arms, may be equipped with an attachment or implement for performing various work functions.

Increasingly, electric or hybrid-electric power sources are being used in power machines, instead of solely using an internal combustion engine. In some power machines, battery packs provide power for a primary system and for a non-primary system. The primary system can be for example the work device or a work group which performs a work function, while the non-primary system can be the drive system for moving the power machine. For example, in a ZTR mower, the mower deck may be designated as the primary system, while the drive system is designated as the non-primary system. In another example, in a loader, the lift arm or work group may be designated as the primary system, while the tractive drive system may be designated as the non-primary system. At various times or conditions of operation, the discharge current available from the battery packs may not be sufficient to meet the needs of both the primary and non-primary systems simultaneously. Controlling these systems to optimize performance, battery condition or other parameters presents a challenge.

In electric or hybrid electric power machines with electric power trains including a battery, an inverter and an electric motor, the power limits of these components are dependent upon their respective temperatures. Without proper power management, the temperature of a particular component may increase beyond a specification limit and result in damage to the component, reduced battery life, or other undesired consequences. Further, as the temperatures of particular components increase, the individual power limits for the particular components may decrease, effecting operation of some or all of the components and of the power machine.

The discussion above is merely provided for general background information and is not intended to be used as an aid in determining the scope of the claimed subject matter.

### SUMMARY

Disclosed embodiments include power machines having an electric power source including at least one battery providing a discharge current output and having a discharge current limit. In an exemplary embodiment, a priority system and a non-priority system are configured to receive power from the discharge current output of the at least one battery. A control system of the power machine is configured to determine, from the discharge current limit, a priority reserve of discharge current for the priority system, a non-priority reserve of discharge current for the non-priority system, and a pool of discharge current separate from the priority reserve and the non-priority reserve. The control system controls allocation of discharge current to the priority system and to the non-priority system as a function of the priority reserve, the non-priority reserve, and the pool.

In another exemplary embodiment, a power machine has an electric power source including at least one battery providing a discharge current output and having a discharge current limit. A first or priority system is configured to receive power from the discharge current output of the at least one battery, with the priority system including at least one priority system inverter and at least one priority system motor. A control system of the power machine is coupled to the electric power source and to the priority system. The control system is configured to: determine a temperature-based scalar for each inverter of the priority system; determine a temperature-based scalar for each motor of the priority system; determine an inverter temperature scalar as a minimum of all temperature-based scalars for all inverters of the priority system; determine a motor temperature scalar as a minimum of all temperature-based scalars for all motors of the priority system; determine a discharge current scalar for the priority system; and determine a power management scalar as a minimum of the inverter temperature scalar, the motor temperature scalar, and the discharge current scalar. The control system is configured to control at least one of the electric power source and the priority system to derate power usage by the priority system based upon the power management scalar.

In another exemplary embodiment, a method is disclosed for controlling power usage by a first system in a power machine having an electric power source including at least one battery providing a discharge current output and having a discharge current limit. The method includes: determining a temperature-based scalar for each inverter of the first system; determining a temperature-based scalar for each motor of the first system; determining an inverter temperature scalar as a minimum of all temperature-based scalars for all inverters of the first system; determining a motor temperature scalar as a minimum of all temperature-based scalars for all motors of the first system; determining a discharge current scalar for the first system; determining a power management scalar as a minimum of the inverter temperature scalar, the motor temperature scalar, and the discharge current scalar; and controlling at least one of the electric power source and the first system to derate power usage by the first system as a function of the power management scalar.

In another exemplary embodiment, a power machine has an electric power source including at least one battery providing a first DC discharge current output. An inverter is coupled to the electric power source and configured to receive the first DC discharge current output from the at least one battery and to provide an AC current output. A motor is coupled to the inverter and configured to receive the AC current output and to responsively operate at a motor speed and produce a motor torque. A control system of the power machine is coupled to the at least one battery, to the inverter, and to the motor. The control system is configured to: determine a maximum power allowed for the at least one battery, the inverter, and the motor; identify a current motor torque of the motor; determine a maximum motor speed from the determined maximum power and the current motor torque; and control the motor, responsive to user input commands, to limit the speed of the motor based upon the determined maximum motor speed.

In some embodiments, the power machine further has a battery temperature sensor configured to measure a battery temperature, an inverter temperature sensor configured to measure an inverter temperature, and a motor temperature sensor configured to measure a motor temperature. In these embodiments, the control system is configured to: determine a maximum battery power limit based upon the measured battery temperature; determine a maximum inverter power limit based upon the measured inverter temperature; determine a maximum motor power limit based upon the measured motor temperature; and determine the maximum power allowed for the at least one battery, the inverter, and the motor by determining a minimum of the maximum battery power limit, the maximum inverter power limit, and the maximum motor power limit.

In another exemplary embodiment, a method is disclosed for controlling current from a battery pack in a power machine having an inverter, a motor, and auxiliary systems. The method includes: identifying a discharge current limit of the battery pack; determining an actual battery pack discharge current; determining an actual inverter current provided from the battery pack to the inverter, as part of the actual battery pack discharge current, for providing an AC current to the motor; subtracting the actual inverter current from the actual battery discharge current to produce a current difference; determining a self-consumption estimate of current consumed by the auxiliary systems from the current difference; determining an inverter current limit by subtracting the self-consumption estimate from the discharge current limit of the battery pack; and using a control system to maintain the actual inverter current at levels which do not exceed the inverter current limit.

According to some aspects of the disclosure, a power allocation method for a power machine can include determining an amount of available power from an electric power source, subtracting from the available power an amount of power used to operate a first motor of the power machine, to determine a remaining available power, determining a power allocation percentage for a second motor of the power machine, and supplying power to the second motor, a magnitude of the supplied power being determined based on multiplying the remaining available power by the power allocation percentage for the second motor.

According to some aspects of the disclosure, a power allocation system for a power machine can include a first electric motor configured to power an auxiliary element of the power machine, a second electric motor configured to power a tractive element of the power machine, and a third electric motor configured to power a workgroup element of the power machine. The power allocation system further includes an electric power source configured to independently power the first electric motor, the second electric motor, and the third electric motor. The power allocation system further includes a battery management system configured to determine an amount of available power from the electric power source, and a machine control unit configured to subtract from the available power an amount of power used to operate the first motor of the power machine to determine a remaining available power, determine a power allocation percentage for the second motor of the power machine, and supply power to the second motor based on the power allocation percentage and the remaining available power.

This summary and the Abstract are provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF DRAWINGS

FIG. 1 is a block diagram illustrating functional systems of a representative power machine on which embodiments of the present disclosure can be advantageously practiced.

FIG. 2 illustrates a perspective view of a representative power machine, in the form of a ZTR mower, on which disclosed discharge power allocation control systems can be practiced.

FIG. 3 is a block diagram illustrating portions of a power machine, such as the ZTR mower shown in FIG. 2, including a control system configured to implement discharge power allocation methods to control maximum discharge current usage by priority and non-priority systems.

FIG. 3-1 is a block diagram illustrating the portions of a power machine shown in FIG. 3, and further illustrating subsystems of the priority and non-priority systems on which the discharge power allocation methods can be utilized in some embodiments.

FIG. 4 illustrates a discharge power map of a battery pack.

FIG. 5 is a table representing discharge current allocation parameters for a particular discharge current limit of a battery pack at a first state of charge under first operating conditions.

FIG. 6 is a graph illustrating an example of reserve scaling of priority and non-priority reserves as available discharge current decreases.

FIGS. 7-9 are tables representing discharge current allocation parameters for discharge current limits of a battery pack under varying operating conditions.

FIG. 10 is an illustration of scaling implemented by a control system as a function of detected motor temperature.

FIG. 11 is an illustration of scaling implemented by a control system as a function of detected inverter temperature.

FIG. 12 is an illustration of a method of determining a power management scaling factor as a function of inverter temperature scalars, motor temperature scalars, and a discharge current scalar.

FIG. 13 is a block diagram illustrating portions of a power machine having an electric power train including a battery pack, an inverter, and an electric motor, with a control system configured to implement motor speed derating.

FIG. 13-1 is a block diagram illustrating the portions of a power machine shown in FIG. 13, and further illustrating a load sense control system which receives load sense inputs, as well as a derated maximum speed of the motor, with the load sense control system configured to generate a derated speed control as a function of the derated maximum speed.

FIG. 14 is a block diagram illustrating control logic implemented by the control systems shown in FIGS. 13 and 13-1 to determine a maximum motor speed and derated speed control.

FIG. 15 is a graph illustrating maximum power derating look-up table functions in one example embodiment.

FIG. 16 is a regulation logic flow diagram illustrating a method of limiting inverter/motor current based upon an estimation of self-consumption of DC current by system of a power machine.

FIG. 17 is a block diagram of a circuit illustrating the self-consumption DC current and inverter DC current controlled using the method represented in FIG. 16.

FIG. 18 is a block diagram of another example configuration of the power machine of FIG. 1.

FIG. 19 is a perspective view of a telehandler that includes the systems represented by the block diagram of FIG. 18.

FIG. 20 is a block diagram of a power system of a power machine such as the telehandler of FIG. 19.

FIG. 21 is flowchart depicting a power allocation method of the power system of FIG. 20.

FIG. 22 is a flowchart depicting an example of a component of the power allocation method of FIG. 21.

FIGS. 23 through 25 illustrate a processing flow for some implementations of the methods of FIGS. 21 and 22.

### DETAILED DESCRIPTION

The concepts disclosed in this discussion are described and illustrated by referring to illustrative embodiments. These concepts, however, are not limited in their application to the details of construction and the arrangement of components in the illustrative embodiments and are capable of being practiced or being carried out in various other ways. The terminology in this document is used to describe illustrative embodiments and should not be regarded as limiting. Words such as “including,” “comprising,” and “having” and variations thereof as used herein are meant to encompass the items listed thereafter, equivalents thereof, as well as additional items.

Some disclosed embodiments include power machines having an electric power source which powers at least one priority system, and typically also at least one non-priority system, which receive discharge current from the electric power source. Control systems of some disclosed embodiments determine from a discharge current limit of a battery of the electric power source a priority reserve of discharge current for the priority system, a non-priority reserve of discharge current for the non-priority system, and a pool of discharge current separate from the priority reserve and non-priority reserve. The control system controls the allocation of discharge current to the priority system and to the non-priority system as a function of the priority reserve, the non-priority reserve, and the pool. In some disclosed embodiments, the control system of a power machine determines an inverter temperature scalar, a motor temperature scalar, and a discharge current scalar. Using these scalars, the control system determines whether a power management scalar which is used to derate power usage by a system such as the priority system should be applied.

Some disclosed embodiments include power machines include an electric power source in which a battery pack provides a DC discharge current output to an inverter which in turn provides an AC current output to a motor. A control system identifies a current motor torque of the motor and determines a maximum power allowed for the battery pack, the inverter, and the motor. From the maximum power allowed and current motor torque, a maximum motor speed is determined and used to limit the speed of the motor. The maximum power allowed for the battery pack, the inverter and the motor can be determined based upon temperatures of these components in order to provide component thermal management for the system.

Conventional power machines may be configured with a power system that includes a power source (e.g., internal combustion engine) configured to power one or more tractive, workgroup, or auxiliary elements of the power machine. For example, conventional power machines may include only a single motor and corresponding hydraulic pump used to power a combination of elements (e.g., each of the workgroup and auxiliary elements of the power machine). Such arrangements may result in over-sizing of the motor and pump, which may lead to inefficient operation of the power machine. In particular, this type of operational system may not be useful in electrically powered machines that use a rechargeable battery system in place of an internal combustion engine. For example, as a result of the over-sizing of a single motor and pump package (which is capable of providing sufficient flow to all systems), the battery of an electric power machine may drain rapidly even when all this flow is not requested/needed by the machine, which may prevent operation through a full workday.

Examples of the present disclosure can address these problems, for example, by providing a power system that includes separate power systems for tractive elements, for workgroup elements, and for auxiliary elements. In some examples, the present disclosure may be integrated into system using one, two, or more tractive motors, workgroup motors, auxiliary motors, or any system that may include one or more motors that may require power to be allocated from one or more power sources.

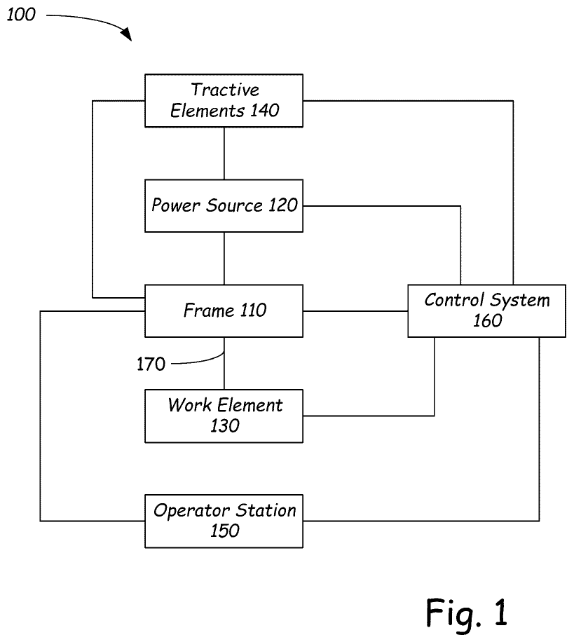

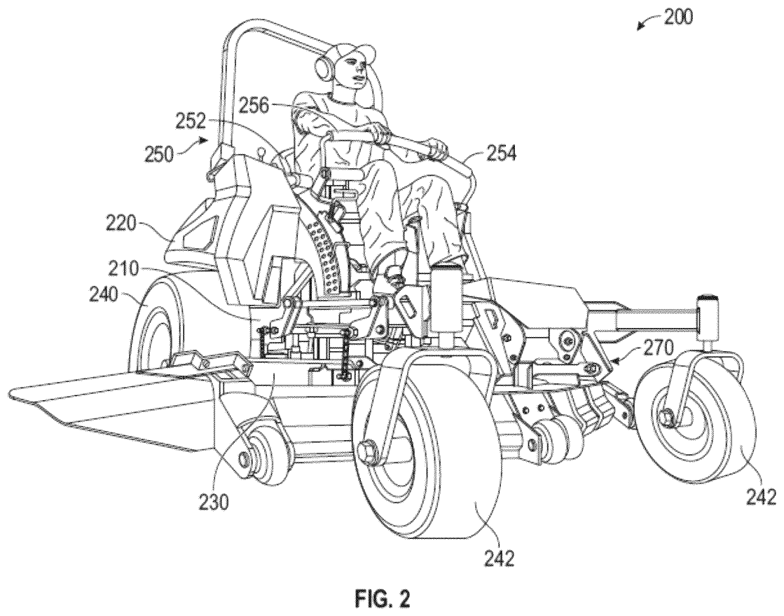

These features, and the more general concepts, can be practiced on various power machines, as will be described below. A representative power machine on which the embodiments can be practiced is illustrated in diagram form in FIG. 1 and one example of such a power machine is illustrated in FIG. 2 and described below before features of more particular embodiments are disclosed. For the sake of brevity, only one power machine is discussed. However, as mentioned above, the embodiments below can be practiced on any of a number of power machines, including power machines of types different from the representative power machines shown in FIGS. 1-2. Power machines, for the purposes of this discussion, include a frame, at least one work element, and a power source that can provide power to the work element to accomplish a work task. One type of power machine is a self-propelled work vehicle, such as a ZTR mower. Other types of power machines include loaders, excavators, utility vehicles, telehandlers, tractors, and trenchers, for example. Self-propelled work vehicles are a class of power machines that include a frame, work element, and a power source that can provide power to the work element. At least one of the work elements is a motive system for moving the power machine under power. Other work elements perform one or more work functions. In ZTR mowers, at least one work element is a mower deck which is powered by the power source.

Referring now more specifically to FIG. 1, a block diagram illustrates basic systems of a power machine 100 upon which the embodiments discussed below can be advantageously incorporated. The power machine can be any of a number of different types of power machines, and the ZTR mower embodiment illustrated in FIG. 2 is only one of numerous examples of power machine 100. The block diagram of FIG. 1 identifies various systems on power machine 100 and the relationship between various components and systems. As mentioned above, at the most basic level, power machines for the purposes of this discussion include a frame, a power source, and a work element. The power machine 100 has a frame 110, a power source 120, and a work element 130. Because power machine 100 shown in FIG. 1 is a self-propelled work vehicle, it also has tractive elements 140, which are themselves work elements provided to move the power machine over a support surface and an operator station 150 that provides an operating position for controlling the work elements of the power machine. A control system 160 is provided to interact with the other systems to perform various work tasks at least in part in response to control signals provided by an operator. For example, the control system 160 can be an integrated or distributed architecture of one or more controllers (e.g., one or more processor devices and one or more memories) that are collectively configured to receive operator input or other input signals (e.g., sensor data) and to output commands accordingly for power machine operations (e.g., workgroup operations, tractive operations, etc.). Under control of the control system, the workgroup work element 130 can be operated to perform work tasks (e.g., mowing, digging, cutting, grading, etc.) and the tractive work elements 140 can be operated move the power machine.

Some power machines have work elements that can perform a dedicated task. For example, some power machines include a mower deck that can be attached to a main frame of the work vehicles in various ways (e.g., with a fixed mount, as an implement attached to a lift arm, etc.). Cutting elements of the mower deck can be controlled as needed. For example, the control system 160 can control the speed of one or more rotating blades, or a position of the mower deck relative to the frame, or the mower deck can be otherwise manipulated to perform mowing or other tasks.

Some power machines can include other dedicated work elements, including cutting or drilling implements, buckets, grading blades, and others as variously known in the art. In some cases, work elements can be interchanged on a particular power machine (e.g., as attachable implements that can be supported by a lift arm, or otherwise). In this regard, for example, the power machine 100 as illustrated includes an implement interface 170, which provides a connection between the frame 110 or the work element 130 and an attachable implement. In some cases, the implement interface 170 can be a direct connection to secure an implement directly to the frame 110 or to the work element 130 (e.g., can be a pinned connection directly to a lift arm). In some cases, the implement interface 170 can include a linkage or other support structure, or can be formed as an implement carrier (e.g., which may be configured to secure and support various implements, and may itself be controllably movable relative to the frame 110 or the work element 130). In some examples, the implement interface 170 can be a pinned or other connection that secures a mower deck to a movable support structure, so that the mower deck can be supported at selected heights relative to the frame 110 (and the ground).

Frame 110 includes a physical structure that can support various other components that are attached thereto or positioned thereon. The frame 110 can include any number of individual components. Some power machines have frames that are rigid. That is, no part of the frame is movable with respect to another part of the frame. Other power machines have at least one portion that can move with respect to another portion of the frame. For example, excavators can have an upper frame portion that rotates with respect to a lower frame portion. Other work vehicles have articulated frames such that one portion of the frame pivots with respect to another portion for accomplishing steering functions.

Frame 110 supports the power source 120, which can provide power to one or more work elements 130 including the one or more tractive elements 140. Power from the power source 120 can be provided directly to any of the work elements 130, tractive elements 140, or implement interfaces 170. Alternatively, power from the power source 120 can be provided to a control system 160, which in turn selectively provides power to the elements that capable of using it to perform a work function. Power source 120 includes electrical sources, or a combination of power sources known generally as hybrid power sources which include an internal combustion engine. In some instances, power source 120 also includes a power conversion system such as a mechanical transmission or a hydraulic system that can convert the output from the power source into a form of power that is usable by a work element.

FIG. 1 shows a single work element designated as work element 130, but various power machines can have any number of work elements. In ZTR mower embodiments of power machine 100, work element 130 includes a mower deck which houses at least one blade for cutting. The mower deck work element is connected to the frame 110 of the power machine by a suspension system 172. In addition, tractive elements 140 are a special case of work element in that their work function is generally to move the power machine 100 over a support surface. Power machines can have any number of tractive elements, some, or all of which can receive power from the power source 120 to propel the power machine 100. Tractive elements can be, for example, track assemblies, wheels attached to an axle, and the like. In the disclosed ZTR mower embodiments, tractive elements 140 include a pair of individually driven rear wheels. Tractive elements can be mounted to the frame such that movement of the tractive element is limited to rotation about an axle (so that steering is accomplished by a skidding action) or, alternatively, pivotally mounted to the frame to accomplish steering by pivoting the tractive element with respect to the frame.

Referring now to FIG. 2, shown is a perspective view of a more particular an embodiment of the power machine shown in FIG. 1. Power machine 200 is a ZTR mower in exemplary embodiments. Mower 200 has a frame 210 which supports a power source 220, an operator station 250, and a work element in the form of mower deck 230. Mower deck 230 is connected to and supported by mower frame 210 by a suspension system 270. Power source 220 can be any suitable power source configured to provide power for the tractive elements 240, the mower deck 230, and any other work element functions. In exemplary embodiments, power source 220 is an electric power system or a hybrid power system, including one or more battery packs.

Operator station 250 can include a seat 252, though in other embodiments a platform for the operator to stand on can be included instead. At the operator station 250, a pair of left and right operator inputs 254 and 256, for example in the form of lap bars, are provided and coupled to a control system (not shown), such as control system 160 shown in FIG. 1, to control power to tractive elements 240 in the form of left and right rear drive wheels. These or other operator inputs are also used to control power to mower deck 230. Mower 200 also includes a pair of non-powered front caster wheels 242.

In exemplary embodiments, the control system of power machine 200 utilizes disclosed methods and techniques for allocating power from the batteries of power source 220 between a primary system and a non-primary system to manage available discharge current and optimize power machine performance over a range of battery charge levels and operating conditions. In an exemplary embodiment, the mower deck 230 (e.g., including motors for operating cutting blades) is considered the primary system and the tractive system (e.g., including drive motors) is considered the non-primary system. At various times or conditions of operation, the discharge current available from the battery packs may not be sufficient to meet the needs of both the primary and non-primary systems simultaneously. Using disclosed methods and techniques of control, power machine performance and battery performance can be improved or optimized.

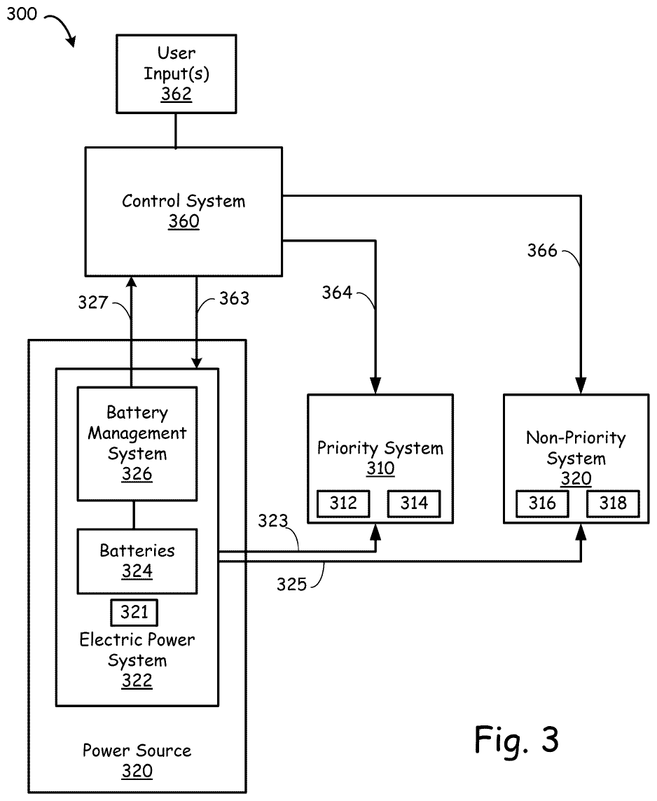

Referring now to FIG. 3, shown in block diagram form are certain components of a power machine 300, which can be an embodiment of power machines 100 and 200 discussed above. As shown in FIG. 3, power source 320 which can be an embodiment of power sources 120 and 220 discussed above includes an electric power system 322. The electric power system has one or more batteries or battery packs 324 which provide an output or discharge current for powering a priority system 310 and a non-priority system 320 of the power machine. For illustrative purposes, the discharge current from battery packs 324 is represented as being provided on current pathways or electrical connections 323 and 325 between the electric power system 322 and the priority and non-priority systems. It should be understood that these current pathways can be provided from other components (not shown) of electrical system 322 which receive power from battery packs 324, for example from one or more inverters or other electrical components. Further, for illustrative and discussion purposes, the total current provided to the priority and non-priority systems through electrical connections 323 and 325 can be considered a total discharge current provided from the battery packs 324. However, battery packs 324 can also provide current to other systems as well.

As discussed with reference to FIG. 2, the priority system 310 can be for example the mower deck of a ZTR mower, while the non-priority system 320 can be the tractive drive system of the mower. In other examples, the priority system can be the lift arm work group of a loader, excavator, or utility vehicle, while the non-priority system is a drive system for that power machine. In some embodiments, actuators or work devices on an implement mounted to the lift arm work group can also be considered part of the priority system, while in other embodiments these implement mounted devices can be considered part of a third system. In general, disclosed control systems and methods can be utilized on a variety of power machines having two or more systems which are powered from the battery packs 324. These example embodiments are not intended to limit use of the invention to a particular type of power machine, nor to particular types of primary and non-primary systems.

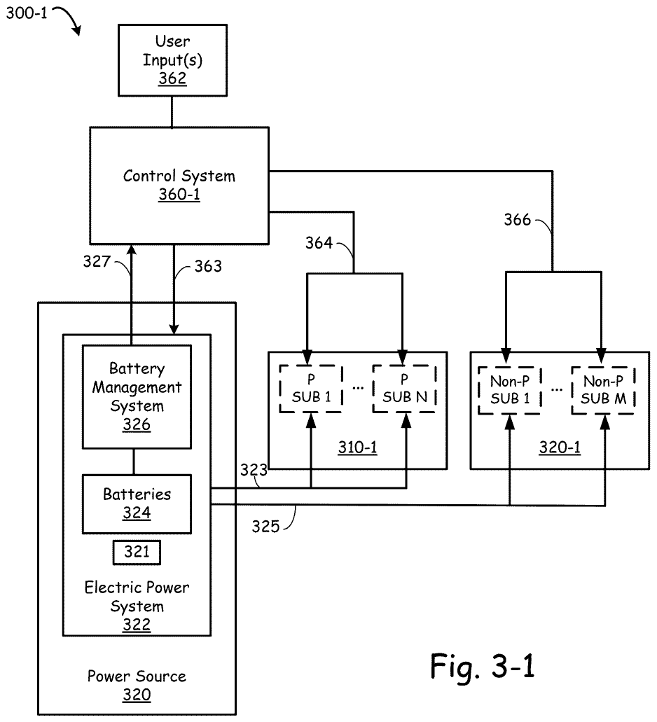

In an exemplary embodiment, electric power system 322 also includes a battery management system (BMS) 326 coupled to the battery packs 324. In other embodiments, BMS 326 can be part of a control system 360. The BMS 326 monitors the battery operating conditions, such as the cell temperature using temperature sensor(s) 321, the state of charge (SOC) and the C-Rate which is a measure of the rate at which the battery packs are discharged relative to their maximum capacity. These battery condition factors or parameters are illustrated in the discharge power map shown in FIG. 4 in one example. Based upon such factors, the BMS 326 provides information to control system 360, through a communication connection 327, which is used by the control system to control the allocation of discharge current from the battery packs 324 to the priority system 310 and the non-priority system 320. In some embodiments, either or both of priority system 310 and non-priority system 320 include inverters and motors. Priority system 310 can further include one or more inverter temperature sensors 312 and one or more motor temperature sensors 314 configured to monitor the temperatures of these devices. Likewise, non-priority system 320 can further include one or more inverter temperature sensors 316 and one or more motor temperature sensors 318 configured to monitor the temperatures of these devices. Control system 360 uses temperature date from these sensors, in some embodiments, to control power delivery to the priority and non-priority systems.

The discharge power map shown in FIG. 4 is a representation of the manufacturer defined battery pack performance characteristics under temperature and operational conditions for various states of charge of the battery pack. From this information, the discharge power limit or discharge current limit of the battery packs can be determined by the BMS 326 and provided to the control system 360. Control system 360 is configured to use the determined discharge current limit and the disclosed discharge current limit allocation methods to determine discharge current allocation parameters. Control system is also configured to use the determined discharge current limit and discharge current allocation parameters to control the maximum currents which can be used by the primary system 310 and the non-primary system 320. In the illustrated embodiment of FIG. 3, control signals 363 are provided from control system 360 to the electric power system 322 to implement such discharge current allocation and control. Further, control system 360 also generates control signals 364 and 366, communicated respectively to priority system 310 and non-priority system 320 to implement work functions, based upon the commands from user input devices 362, the determined discharge current limit, and the determined discharge current allocation parameters. The various communication connections between electric power system 322, control system 360, priority system 310 and non-priority system 320 can be wired communications for example using data buses, or can be wireless communication connections. Also, while an exemplary embodiment illustrates BMS 326 as being part of the electric power system 322 of power source 320, in other embodiments the BMS 326 can be part of control system 360. In one specific alternative embodiment, instead of (or in addition to) the control system 360 providing control signals 362 to the electric power system 322, the control signals 364/366 may include power or current draw limits from the respective priority and non-priority systems. For example, limiting max current draw from a non-priority inverter.

Again referring to FIG. 4, as an example of operation of BMS 326, the BMS monitors cell temperatures and state of charge of a battery pack continuously or at regular intervals. If the cell temperature is for example 60° C. while the state of charge is at 100%, the corresponding C-Rate for the battery pack can be determined. This C-Rate, which represents the amount of current that can be discharged at that temperature to completely discharge the battery pack in one hour of time, can be the discharge current limit information provided from BMS 326 to control system 360 in exemplary embodiments. In this example, the battery pack C-Rate could be the battery pack's maximum rating, for example 500 amps. As the battery pack discharges at this maximum discharge current, the temperature will tend to increase, while the state of charge decreases. As these conditions change, the BMS 326 updates the control system to limit the discharge current accordingly. For example, as the battery temperature increases, the BMS typically provides a lower maximum discharge current, for example 200 amps, to control system 360. The control system then controls the allocation of this reduced discharge current limit. Example methods of determining the discharge current allocation parameters used by control system 360 are described below.

Disclosed embodiments can also be implemented with either or both of primary system 310 and secondary system 320 including two or more subsystems. For example, in power machine 300-1 shown in FIG. 3-1, primary system 310-1 is shown to include N subsystems, while secondary system 320-1 is shown to include M subsystems. While the discharge current limit is used to allocate discharge current between the primary system and the secondary system, further allocation or division of the discharge current provided to the primary or secondary system can also be implemented using the disclosed techniques. For example, in embodiments in which the primary system 310-1 is the lift arm work group of a power machine, including current provided to work devices on an attached implement, the lift arm actuators can be grouped as one subsystem of the primary system, while the implement work devices are grouped as a second subsystem. The current allocation between these subsystems can then be determined after the current allocation between primary system 310-1 and secondary system 320-1 are determined. Further, in some embodiments, the discharge current allocation within a system can be controlled using the control circuitry of one or more inverters in the system.

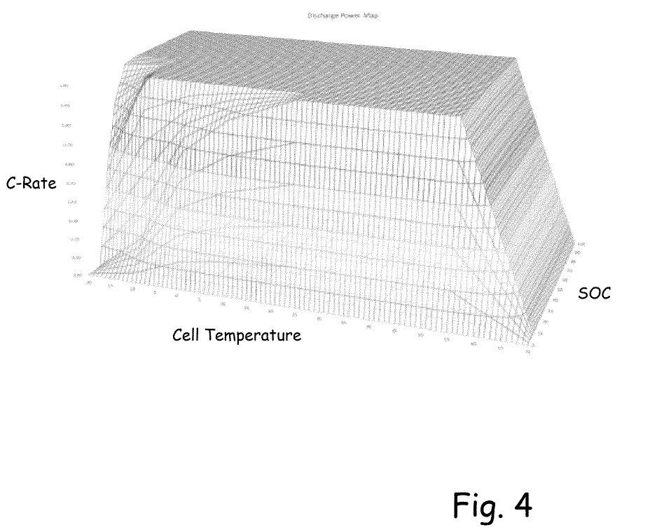

Referring now to FIG. 5, shown is a table 500 which represents a particular discharge current limit and allocation parameters for the particular discharge current limit. The illustrated discharge current limit 502, represented by the width of the table 500, is the available instantaneous discharge current from the battery pack 324 based upon current SOC and temperature, as determined by BMS 326. Disclosed embodiments control discharge current allocation by defining a priority reserve 504, a non-priority reserve 506, and a pool 508 which together equal the currently defined discharge current limit. The priority reserve 504 is defined as the portion of the discharge current limit 502 that the priority system 310 is authorized to utilize if necessary. The priority reserve is the amount of the discharge current limit that is reserved solely for use by the priority system. The non-priority reserve 506 is defined as the portion of the discharge current limit 502 that the non-priority system 320 is authorized to utilize if necessary. The non-priority reserve is the amount of the discharge current limit that is reserved solely for use by the non-priority system. The pool 508 is defined as the remainder of the discharge current limit 502 not reserved by the priority and non-priority systems.

Once control system 360 has defined or identified the priority reserve, non-priority reserve, and pool for the discharge current limit, control system 360 calculates a priority limit 510 which is the maximum amount of the available discharge current limit 502 that the priority system 310 is authorized to utilize. The actual amount of current being used by the priority system is defined as the priority demand 512. The priority demand 512 can be determined by the sum of the instantaneous currents at the DC side of the priority system inverters. Control system 360 also calculates a non-priority limit 514 which is the maximum amount of the available discharge current limit 502 that the non-priority system 320 is authorized to utilize. The actual amount of current being used by the non-priority system is defined as the non-priority demand 516. The non-priority demand 516 can be determined by the sum of the instantaneous currents at the DC side of the non-priority system inverters. The priority limit 510 can be determined or calculated using the relationship: priority limit=Max(Discharge Current Limit−Min(Non-Priority Reserve, Non-Priority Demand), Priority Reserve). The non-priority limit 514 can be determined or calculated using the relationship: non-priority limit=Max(Discharge Current Limit−Priority Demand, Non-Priority Reserve).

With the discharge current limit 502 dictating how much current is available to use, control system 360 allocates available use of that current by priority system 310 and non-priority system 320 based upon their respective reserves 504 and 506, their respective demands 512 and 516, and whatever current from the pool 508 is available. The two systems 310 and 320, based on what their demand is with respect to the overall limit, are competing for how much of the overall discharge current limit that they use. In the example shown in the FIG. 5, the limits 510 and 514 are established such that the priority system 310 can take its entire reserve 504 and it has the authorization to consume the entire pool 508. Non-priority system 320 can take its entire reserve 506, but is only authorized to consume the portion of the pool 508 that the priority system does not require at any given time. Depending upon the priority and non-priority demands 512 and 516 at any given time, and as the discharge current limit 502 is reduced over time or based upon operating conditions resulting in a smaller available pool 508, there may not be sufficient discharge current available to allow the primary system 310 to draw current at the initially determined priority reserve level and to allow the non-primary system 320 to draw current at the initially determined non-priority reserve level. To allocate the available current, scaling of the reserves is necessary.

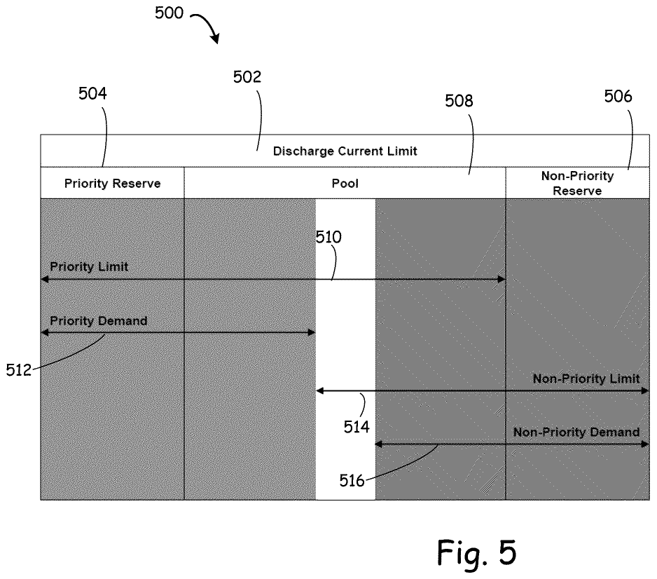

FIG. 6 is a graph illustrating an example of reserve scaling as the available discharge current decreases. The graph illustrates the pool 508, a scaled or adjusted non-priority reserve 506-1, and a scaled or adjusted priority reserve 504-1. At the far left of the graph, with the discharge current limit 502 at the maximum for the battery pack (e.g., 500 amps in this example), the adjusted priority reserve and the adjusted non-priority reserve have not been scaled and are the same as originally calculated and represented in FIG. 5. As the discharge current limit 502 is reduced, for example due to a decrease in the SOC and/or an increase in the cell temperature, the priority and non-priority reserves remain unchanged, but the pool 508 is reduced. When the discharge current limit 502 has dropped to the point that the pool is zero, any further drop in the discharge current limit will result in there being insufficient available current to maintain the priority reserve and the non-priority reserve at their initially calculated levels. In other words, a combination of the initially calculated priority reserve and the initially calculated non-priority reserve is greater than the discharge current limit. As shown in FIG. 6, at this point the adjusted priority reserve 504-1 and the adjusted non-priority reserve 506-1 are reduced, to maintain a particular ratio or according to other predetermined relationships, and such that combined they are equal to the discharge current limit.

As discussed, in some exemplary embodiments, scaling of the priority and non-priority reserves by control system 360 is based upon a ratio, with the total discharge current limit divided by the sum of the two reserves. As such the reserve ratio used to divide the available discharge current once scaling is required can be determined or calculated using the relationship: reserve ratio=(discharge current limit)/(priority reserve+non-priority reserve). The adjusted priority reserve 506-1 can then be determined or calculated using the relationship: adjusted priority reserve=Min(priority reserve, priority reserve*reserve ratio). The adjusted non-priority reserve can be determined or calculated using the relationship: adjusted non-priority reserve=Min(non-priority reserve, non-priority reserve*reserve ratio).

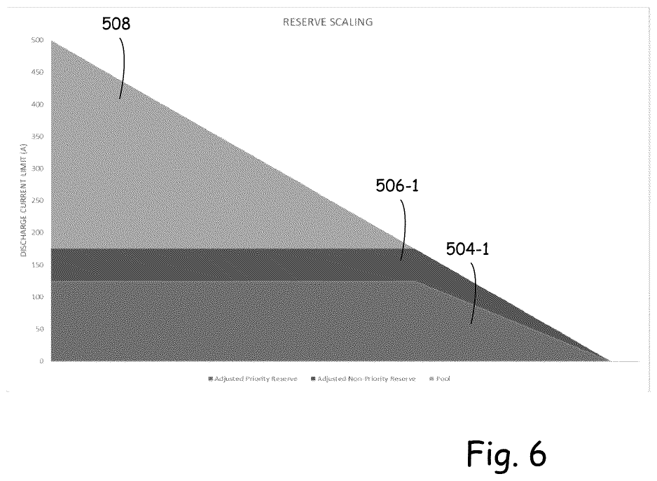

Referring now to FIGS. 7-9, shown are examples of the above-described methods of setting the priority and non-priority limits under differing conditions and utilizing reserve scaling. In FIG. 7, for a particular discharge current limit of the battery packs, if priority demand requires use of most or all of pool 508, the non-priority limit is reduced accordingly so that the priority system has sufficient power to perform its work function under a particular condition. Using the relationship defined above, and as illustrated in FIG. 7, the non-priority limit 514 is set to the value of whichever is greater, the non-priority reserve 506 or the difference between the discharge current limit 502 and the priority demand 512. In this case, the difference between the discharge current limit and the priority demand is greater than the non-priority reserve so the non-priority limit 514 is set accordingly. However, the non-priority limit remains equal to the discharge current limit 502 minus the priority demand.

As an example, in a ZTR mower embodiment of the power machine with the mower deck being the priority system, if the mower is traveling and moves over a dense patch of grass such that the priority demand 512 and the non-priority demand 516 overlap and together require more than the discharge current limit 502, the control system lowers the non-priority limit 514 of the drive system to a value which is less than the non-priority demand 516 (e.g., the current required to power the drive system at the user commanded speed) to ensure that the mower deck (the priority system) has sufficient discharge power available to achieve an acceptable quality of cut. Since the non-priority system demand is greater than its adjusted non-priority limit, the control derates discharge current to the non-priority system to the non-priority limit. This allows both of the priority and non-priority systems to continue to operate without exceeding the discharge current limit at a given time.

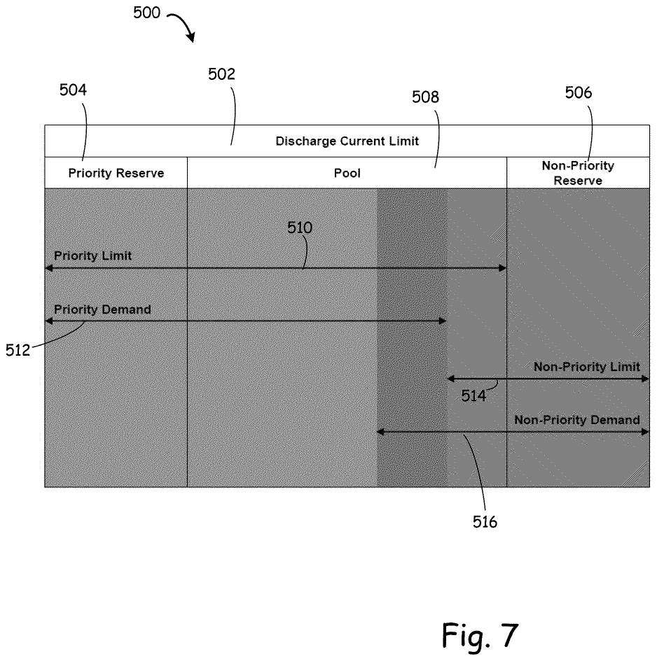

FIG. 8 illustrates the discharge current allocation by the control system in situations where the priority demand 512 exceeds the priority limit 510. As shown, the priority limit is set such that the priority system can utilize the priority reserve 504 and the entirety of the pool 508. However, the priority system is prevented from using the portion of the discharge current limit 502 which is designated for the non-priority reserve 506. Thus, instead of letting the priority system (e.g., the mower deck in a ZTR mower embodiment) utilize as much current as demanded based upon the conditions (e.g., tall grass) and based upon the user input, the control system limits the priority system to ensure that the non-priority system (e.g., the drive system) has sufficient current to continue to function. As both of the priority demand 512 and the non-priority demand 516 exceed the respective limits 510 and 514, both of the priority system and the non-priority system are derated. As the power system determines the priority and non-priority limits and the priority and non-priority demands continuously or at short intervals, derating one or both of the priority and non-priority systems can produce self-regulation in some instances. For example, as the drive system is derated and ZTR mower speed is reduced, the demand on the mower deck will frequently be reduced. The control system can then increase the limits 510 and 514 accordingly.

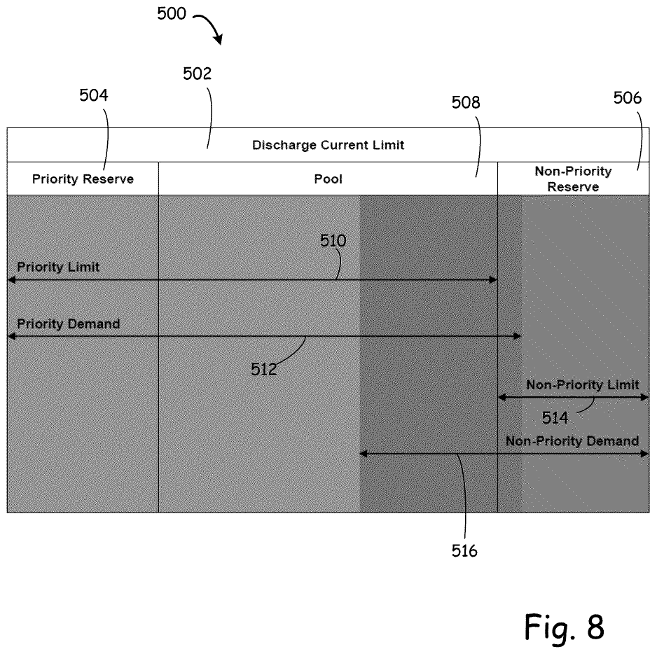

FIG. 9 illustrates a scenario where the discharge current limit 502 is high enough to allow both of the priority and non-priority system to utilize the discharge current required by the respective priority demand 512 and the non-priority demand 516. In this example, the priority demand 512 is shown to be less than the priority reserve 504. An example of such a situation can be when the blades of the mower deck of a ZTR mower are rotating but not actively cutting grass. In such situations, the non-priority limit 514 is set to allow the non-priority system (e.g., the drive system) to use the entire nonpriority reserve 506, the entire pool 508, and whatever portion of the priority reserve 504 that is not being used by the priority system. The same is true for the priority system which would be allowed to use part of the non-priority reserve 506 if not being used by the non-priority system. However, in some specific embodiments the control system may not allow the non-priority system to utilize any of the priority reserve (even when available).

As discussed with reference to FIG. 3, control system 360 is further configured, in some embodiments, to monitor inverter and motor temperatures in priority system 310 and non-priority system 320 using sensors 312, 314, 316 and 318, and to implement control schemes based on the measured motor and inverter temperatures. Suppliers of motors and inverters provide temperature limits for these components. For the inverter, in an example the temperature limit is 95° C., and at that point the inverter should be disabled to protect the component. For a motor, in an example, the temperature limit is 145° C., and at that temperature the motor should be disabled.

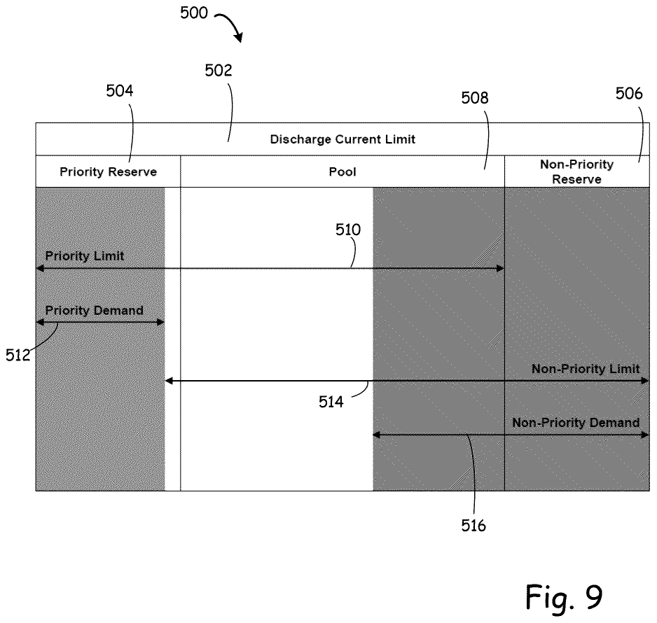

Referring now to FIG. 10, shown is an example of scaling functionality implemented by control system 360 as a function of detected motor temperature. In the illustrated embodiment, the temperature limit for the motor is 145° C. In the disclosed scheme, the scaler or scaling function used by the control system is a simple linear degrade to scale back battery usage by the motor as a function of temperature. Control system 360 is configured to scale between an initial scaling temperature, for example 120° C., which is lower than the specified temperature limit provided by the supplier, and the temperature limit for the motor. In FIG. 10, a scaling factor or scalar of 1 indicates that no degrade in performance is required, and at the limit temperature the scaling factor reaches 0. With the scaling factor applied to the speed command for the motor, for example by multiplication, the speed command is completely attenuated and the motor is disabled.

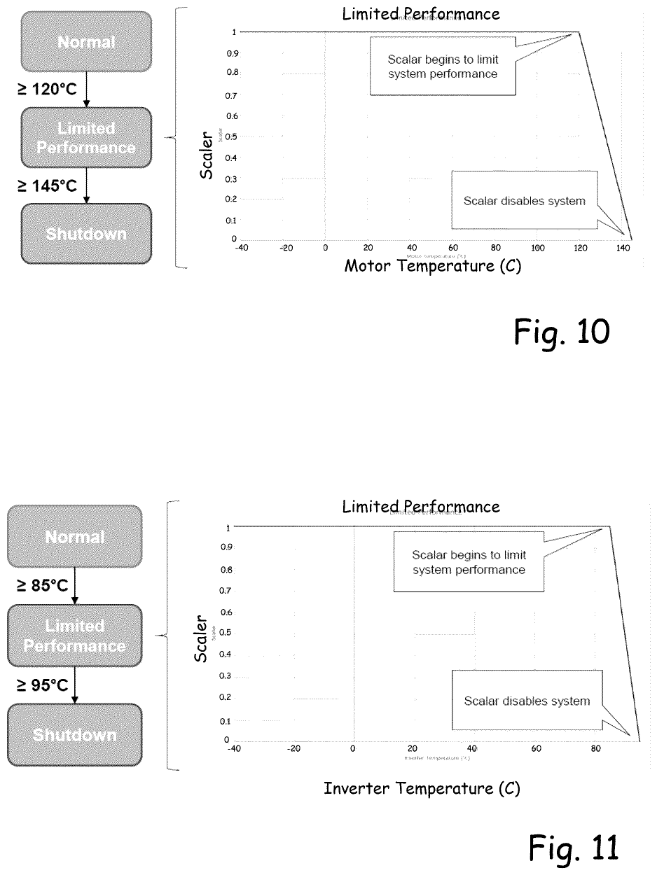

Referring to FIG. 11, shown is an example of scaling functionality implemented by control system 360 as a function of detected inverter temperature. Below an initial scaling temperature, for example 85° C., a scaling factor or scalar of 1 is applied to a commanded amount of current. Between the initial scaling temperature and the temperature limit for the inverter, for example 95° C., the scaling factor is reduced linearly between 1 and 0. At or above the limit temperature, the scaling factor is set to 0 and the inverter is disabled.

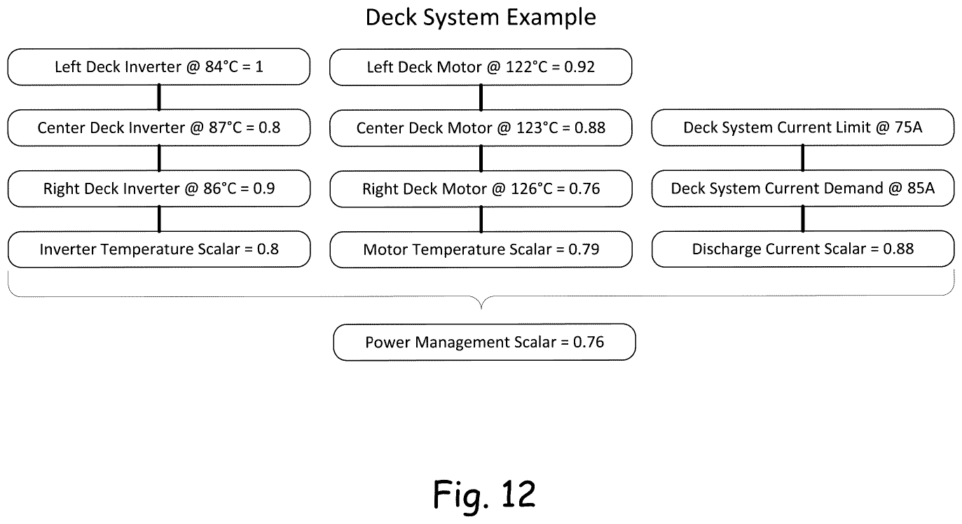

FIG. 12 illustrates an example of a method used in some embodiments by control system 360 to determine a power management scaling factor or scalar for use in derating discharge current provided to a system having multiple actuators such as motors, and multiple inverters. The method takes into consideration the temperature limitations of the inverters and motors, as well as the discharge current allocation techniques described above which limit current when the current demand exceeds the current limit due to battery pack SOC or other factors. In this illustrated example, the priority system 310 is a mower deck including a left deck inverter and a left deck motor, a center deck inverter and a center deck motor, and a right deck inverter and a right deck mower.

In exemplary embodiments, a separate scalar is determined for each inverter and for each motor. These scalars can be predefined as functions of temperature for the inverters and motors. As the inverters and mowers typically have different temperature limits, the predefined functions of temperature will be different for inverters and motors. These functions can be, for example, implemented in look-up tables correlating particular temperatures to particular scalars, or using linear functions as described with reference to FIGS. 10-11.

The inverter temperature scalar is defined as the minimum scalar when considering each scalar produced based on inverter temperatures in the system. The motor temperature scalar is defined as the minimum scalar when considering each scalar produced based upon motor temperatures in the system. The discharge current scalar is the ratio of system current limit (e.g., priority limit 510) with respect to system current demand (e.g., priority demand 512). The power management scalar is defined as the minimum of the inverter temperate scalar, the motor temperature scalar, and the discharge current scalar. The power management scalar for a system (e.g., the priority system) is then used by the control system to derate the discharge current provided to that system responsive to user inputs commanding operation of that system.

In the illustrated example, the temperature of the left deck inverter is at 84° C., the temperature of the center deck inverter is at 87° C., and the temperature of the right deck inverter is at 86° C. Assuming that all inverters are of the same type and have the same temperature limit, the inverter that is the hottest has the lowest scaling factor, which becomes the overall inverter temperature scalar applying the most severe derate. In this example, the center deck inverter scalar is 0.8, so this value is used as the inverter temperature scalar. As shown in FIG. 12, the left, center and right deck motors have temperatures of 122° C., 123° C., and 126° C. The right deck motor, with a temperature of 126° C., requires the greatest derate and therefore has the lowest scalar of 0.76. Therefore, the motor temperature scalar for the system is set to this value. The control system 360 also looks at the discharge current demand and discharge current limit of the deck system. In examples in which the mower deck is the priority system 310, this is the priority demand 512 and the priority limit 510. The deck system demand in the example of FIG. 12 is 85 A, but the limit is only 75 A, creating a derate using the method described above. Dividing the 75 A deck system current limit by the 86 A deck system current demand produces a discharge current scalar of 0.88.

Control system 360 sets the power management scalar to the lowest or minimum of the inverter temperature scalar, the motor temperature scalar and the discharge current scalar so that the component closest to having a temperature issue is addressed. In the example shown in FIG. 12, controls system 360 sets the power management scalar to the motor temperature scalar, and is thus based upon the scalar determined for the right deck motor. The power management scalar is then used to control system functions, for example used to derate one or more of torque, speed, current, or other parameters based on the particular control system. For example, in the case of a mower deck, if the deck system is allowed to run at 1000 rpm, the scalar can be applied to derate that speed and set the speed limit to 760 rpm so that the inverters and motors can cool off, or so that the current can back down.

In exemplary embodiments, the above-described process of setting a power management scalar is done for each system, so also for the drive (non-priority) system in this example. For the drive system, a separate power management scalar would take into account a discharge current scalar for the drive system, an inverter temperature scalar for the drive system, and a motor temperature scalar for the drive system. In some embodiments, each system is then derated independently of the derating of the other system. The separate power management scalars are then used to derate the corresponding systems, limiting motor speed, torque, current discharge, etc.

While the derating of a particular system can be implemented through separate derating of individual components, for example limiting motor speed or torque of each motor separately, in other embodiments the derating of components such as motors can be implemented by the inverters. Typically, inverters are configured such that once the amount of DC current to the inverter is set, the inverter can control distribution of the current output from the inverter. This allows some of the processing to be offloaded from control system 360 if desired. For example, for a ZTR mower power machine, the control system can determine that the battery pack can provide 100 amps, and that the mower deck priority system is to be allocated 60 amps, while the drive non-priority system is allocated 40 amps. It can then be left to the inverter control system within the mower deck or drive system to control the allocation of current within that system according to the techniques and methods described above.

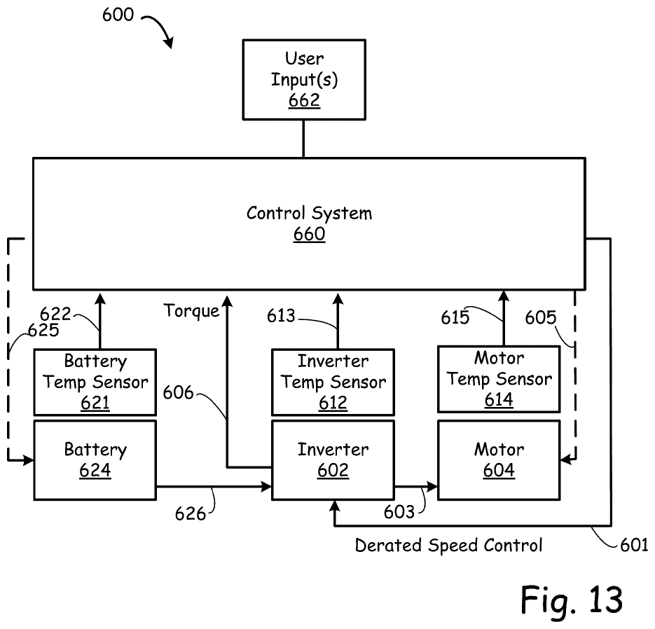

Referring now to FIG. 13, shown in block diagram form are certain components of a power machine 600, which can be an embodiment of power machines 100 and 200 discussed above. Features of power machine 600 can also be included in, or in conjunction with, the features of power machine 300. Further, the illustration of features of power machine 600 is simplified for discussion purposes, but the invention is not limited to the particular configuration illustrated. For example, while a battery management system is not shown, the invention can be implemented in conjunction with a battery management system.

As shown in FIG. 13, power machine 600 includes an electric power system or electric drive train having one or more batteries or battery packs 624, an inverter 602, and an electric motor 604. Discharge current from battery packs 624 is provided on current pathway or electrical connection 626 between the battery packs 624 and inverter 602. In some embodiments, control of the DC current provided to inverter 602 can be provided at least partially through control signals 625 between control system 660 and the battery packs 624 or associated circuitry such as switches or relays. In other embodiments, control of the current provided to inverter 602 from battery packs 624 is provided by communication between control system 660 and inverter 602 through control signals 601. Control signals 601 can include a number of different control commands and parameters, one of which in some embodiments is a derated speed control command or signal described below in further detail. Under control from control system 660 responsive to commands from user input(s) 662, AC current is provided from inverter 602 to motor 604 through electrical connection 603. In some embodiments, the control system 660 can also provide control signals 605 to the motor 604. The control signals 601, 605 and 625 can be provided through controller area network (CAN) bus connections, through wireless connections, or via other types of connections between the control system and components.

Power machine 600 also includes a battery temperature sensor 621 configured to provide battery temperature data 622 to control system 660, an inverter temperature sensor 612 configured to provide inverter temperature data 613 to control system 660, and a motor temperature sensor 614 configured to provide motor temperature data 615 to control system 660. The temperature sensors 621, 612 and 614 can be separate temperature sensors or can be temperature sensors which are integral to the battery packs 624, inverter 602, or motor 604. Inverter 602 also provides torque data 606 to control system 660. The torque data 606 is indicative of the instantaneous torque generated by motor 604. In exemplary embodiments, control system 660 is configured to manage the power output of the system using the temperatures of the battery packs, the inverter and the motor in conjunction with the instantaneous motor torque data 606. Control system 660 uses the temperature and torque data to identify the temperature dependent maximum powers of each of the battery packs 624, inverter 602 and motor 604. Using an identified maximum power and the instantaneous torque, the control system determines a maximum motor speed (RPMs), which may be less than the highest speed capabilities of the motor. The maximum motor speed is then used in providing derated speed control signals 601 to inverter 602. With the temperature and torque data continuously updated, the derated speed control is provided in a closed loop which allows rapid adjustments to motor speed as the machine operating conditions and/or user input commands change.

Referring for the moment to FIG. 13-1, shown in block diagram form is a power machine 600-1 which can be an embodiment of the power machine 600 shown in FIG. 13. Power machine 600-1 and FIG. 13-1 differ from power machine 600 and FIG. 13 only in the inclusion of a load sense control system 670 in power machine 600-1. Load sense control systems, such as systems which sense pump pressure and limit motor speed based upon the pump pressure and other parameters, can use the maximum motor speed 671 determined by the control system 660 as an input parameter. Other load sense inputs 672 can include pressure values, pressure differential values, pressure targets, upper and lower speed limits, etc. An example of such a load sense system is provided in U.S. Provisional Patent Application No. 63/595,579, filed on Nov. 2, 2023 and entitled SYSTEM AND METHODS FOR CONTROL OF EXCAVATORS AND OTHER POWER MACHINES, which is hereby incorporated by reference in its entirety. Load sense control system 670 can be implemented within the same controllers as control system 660 in some exemplary embodiments. Using the maximum motor speed 671 and other load sense inputs, load sense control system 670 is configured to generate the derated speed control 601.

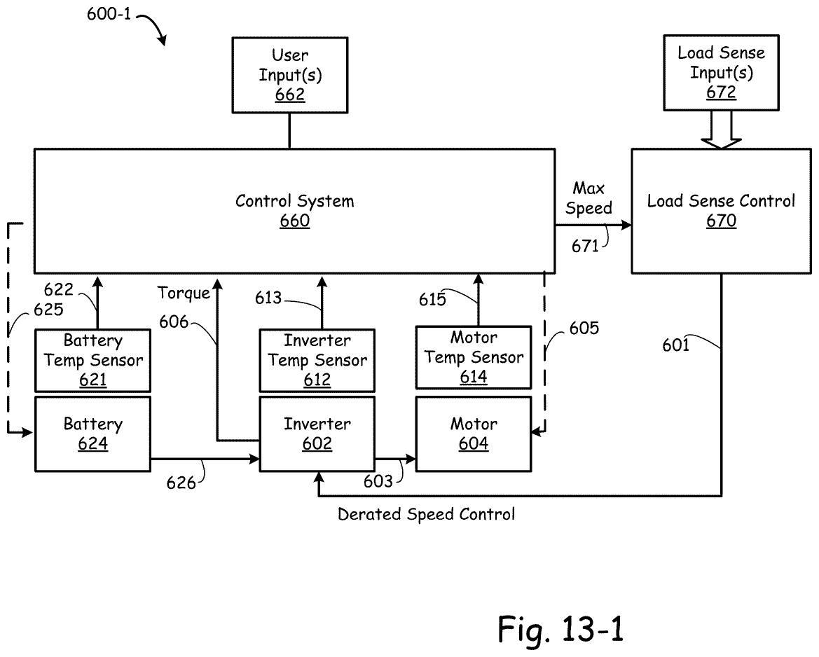

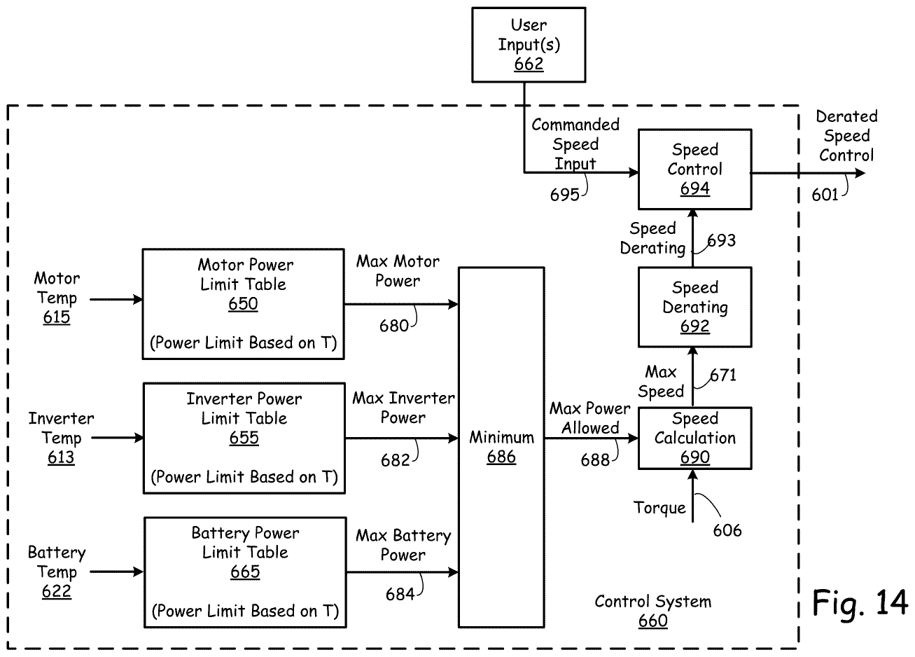

Referring now to FIG. 14, shown in block diagram form are control logic and functions implemented by control system 660 to determine the maximum motor speed 671 and derated speed control 601 in exemplary embodiments. Control system 660 includes look-up tables 650, 655, and 665 which contain derating data or maximum power data, as a function of temperature, for each of motor 604, inverter 602 and battery packs 624. Using the respective motor temperature 615, inverter temperature 613, and battery pack temperature 622, the look-up tables identify the maximum allowed power for each of these components based upon the current temperature of the component. FIG. 15 provides a graphical representation of the derating or maximum power look-up tables for each of the motor, inverter, and battery packs as functions of measured temperatures in one example embodiment. As can be seen in FIG. 15, the maximum power of each component as a function of temperature differs. In the illustrated embodiment, the battery is the most temperature sensitive and requires a reduction in maximum power at a lower temperature than the inverter or motor. The motor is frequently designed to operate at the highest temperatures, and therefor requires a reduction in the maximum power at the highest temperatures of the three components.

From the look-up tables, the maximum motor power 680, the maximum inverter power 682 and the maximum battery pack power 684 are compared at minimum determining function 686 to identify the lowest of the maximum allowed powers of these components. This minimum of the different temperature dependent maximums 680, 682 and 684 is the determined maximum power allowed 688. With the maximum power allowed 688 determined, and the current torque motor torque 606 provided by the inverter, a speed calculation function 690 determines the maximum motor speed allowed. Motor speed as a function of power and torque can be determined by the relationship:

$$Speed = \frac{6000 * Power}{2 * π * Torque}$$

With the maximum power allowed 688 determinations updated in real-time, and with an instantaneous torque provided, a closed-loop system is created and the maximum motor speed 671 is also updated in real-time. Using the determined maximum motor speed 671, speed derating function 692 can be used to generate speed derating parameters or data 693. The speed derating parameters 693 can be any algorithm, functions or relationships which limit the motor speed, responsive to commanded speed inputs 695 from user inputs 662, to motor speeds below maximum speed 671. For example, the speed derating parameter can be a ratio or percentage, applied to any commanded speed, which is based upon a ratio of the maximum motor speed 671 after derating and the maximum motor speed with no derating. The speed derating function 692 can use other relationships, including step-wise linear functions, truncating functions, etc. to determine the speed derating parameters 693. Speed control function 694 receives the commanded speed input 695 and the speed derating parameters and responsively generates the derated speed control 601. As discussed, the speed derating function 692 and speed control function 694 can, in some embodiments, be implemented by a load sense control system which also takes into account other load sense inputs.

Using disclosed embodiments, a power machine can manage power usage through motor speed to provide thermal management for the battery packs, inverter, and motor. For example, when a power machine such as an excavator is under heavy load and requires high torque, the motor speed and corresponding speed of movement of the lift arm work group are limited such that the power used does not exceed the maximum power allowed. This could for example be the case while digging. When there is no longer a need for the higher torque, the motor speed is allowed to increase, which in turn can allow the lift arm to move at a higher speed as well.

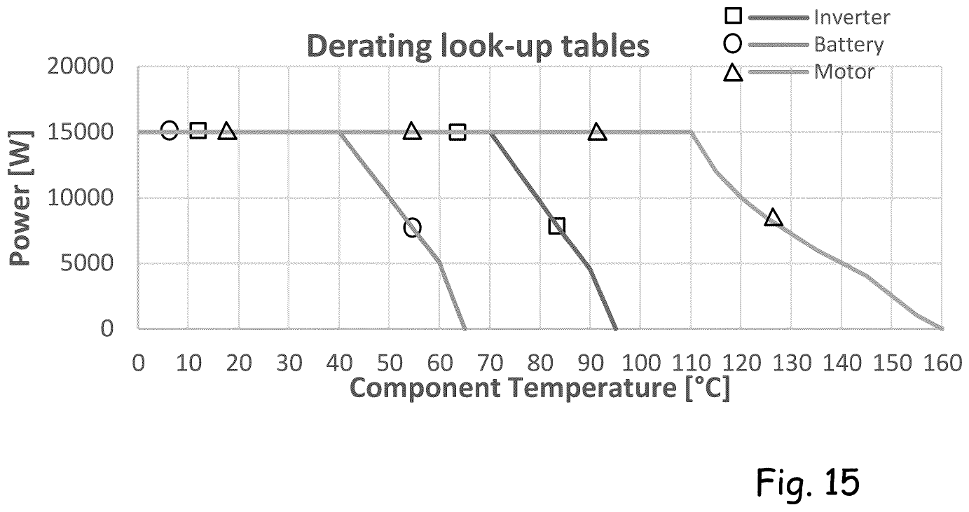

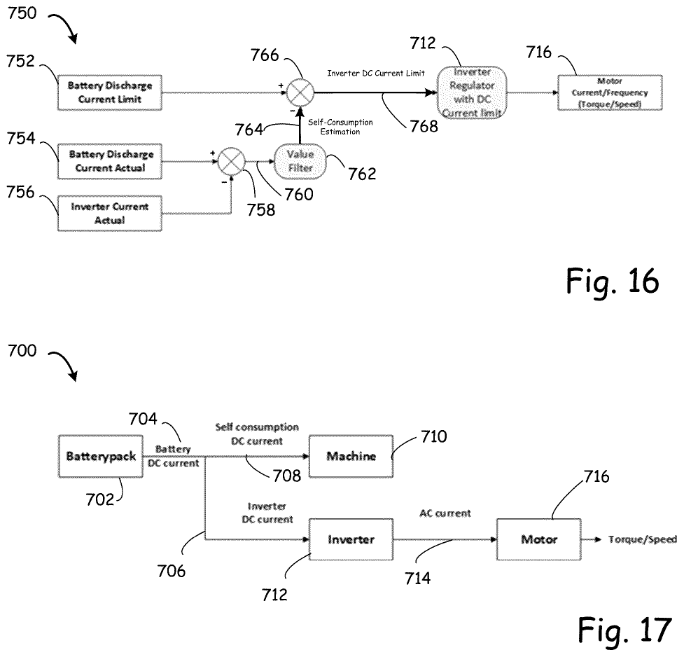

Referring now to FIG. 16, shown is a block diagram illustrating a method of limiting inverter/motor current based upon an estimation of self-consumption of DC current by secondary or auxiliary systems of the power machine. FIG. 17 is a block diagram of a circuit illustrating the self-consumption of DC current and of inverter DC current controlled using the method represented in FIG. 16. As shown in FIG. 17, a power machine 700 has one or more battery packs 702 which provide a total DC discharge current 704, a portion of which is used by the inverter 712 to provide AC current to motor 716, for example using the methods disclosed above. Another portion of the total discharge current 704 is used by secondary or auxiliary systems represented in FIG. 17 as machine 710. Such secondary or auxiliary systems can include systems such as the HVAC system, the control system, the lighting systems, etc. In FIG. 17, the total discharge current 704 is shown to include the inverter DC current 706 which is used by the inverter to supply the motor AC current 714, and the “self-consumption” DC current 708 provided to the machine 710. Without a regulating component such as inverter 712, or other current measuring components added at an increased cost, it is difficult to identify the magnitude of self-consumption DC current 708 provided to the machine 710. Such secondary or auxiliary systems typically do not provide any measurement of their power usage at a given time. This presents difficulty in setting the power and current provided to the inverter 712 and motor 716. When providing a maximum power from the battery packs 702, for example determined using the above-described methods and systems, if the self-consumption DC current 708 is higher than expected, the total discharge current from the battery packs 702 can exceed battery pack specifications and cause overheating and damage. The inverter DC current 706 can also be less than expected, resulting in a loss of power and resulting difficulty in performing machine functions as intended.

FIG. 16 illustrates a method 750 of setting an inverter DC current limit which takes into account self-consumption DC current. As shown at block 752, a battery discharge current limit is identified for battery pack 702. This battery discharge current limit can be determined as a function of temperature, state of charge (SOC) and C-Rate as discussed above, or it can be set using other control criteria. As shown at blocks 754 and 756, the actual battery DC discharge current 704 and the actual inverter DC current 706 are determined. As shown by subtraction component 758, the actual inverter current 756 is subtracted from the actual battery discharge current 754 to produce a current difference 760. As shown at block 762, optional value filtering of the current difference produces a self-consumption estimate 764, which is an estimate of the instantaneous self-consumption DC current 708 used by the machine 710. The self-consumption estimate can also be set to the current difference 760 without value filtering. The inverter DC current limit 768 is then determined by subtracting the self-consumption estimate 764 from the battery discharge current limit 752 as shown by subtraction component 766. The control systems described above are in some embodiments configured to maintain the inverter DC current 706 at levels which do not exceed the inverter DC current limit 768.

As discussed above, conventional power machines may be configured with a power system that includes a power source configured to power one or more tractive, workgroup, or auxiliary elements of the power machine. Some such machines may include only a single motor and corresponding hydraulic pump used to power a combination of elements (e.g., each of the workgroup and auxiliary elements of the power machine). This type of arrangement can result in over-sizing of the motor and pump, which may lead to inefficient operation of the power machine. Similarly, in electrically powered machines that use a rechargeable battery system in place of an internal combustion engine, over-sizing of a single motor and pump package which is capable of providing sufficient flow to all systems can result in the rapid draining of the battery, even though all of the flow is not requested/needed by the machine, which may prevent operation through a full workday.

Some exemplary embodiments of the present disclosure can address these problems, for example, by providing a power system that includes separate power systems for tractive elements, for workgroup elements, and for auxiliary elements. In some examples, the present disclosure may be integrated into a system using one, two, or more tractive motors, workgroup motors, auxiliary motors, or any system that may include one or more motors that may require power to be allocated from one or more power sources.

In some examples, a first power system may include a hydrostatic tractive motor, a hydrostatic drive pump, and an electric drive motor that collectively power one or more tractive elements (e.g., axles, wheels, etc.). A second power system may include a workgroup electric motor and a workgroup hydraulic pump that collectively power one or more workgroup elements (e.g., lift arms, implements, etc.). A third power system may include an auxiliary electric motor and an auxiliary hydraulic pump used to power one or more auxiliary elements (e.g., power steering, braking, hydrostatic charge, cooling, or other non-tractive, non-workgroup components).

In some examples, each of the separate first, second, and third power systems may be independently controlled based on the current operation of the power machine. For example, when the power machine receives a travel command, power may be sent to the first power system to operate the one or more tractive elements, but may not be sent to the second power system to operate the one or more workgroup elements. Similarly, if no workgroup or travel command is received, power may not be sent to either of the first or second power systems, while the third power system may be powered to provide cooling, steering, or other auxiliary functions. Thus, each of the motors or pumps may be sized appropriately for their intended use to prevent over-sizing and reduce unneeded power draw from the power source.

In one particular example, the third power system may receive constant power from the power source (e.g., whenever the power machine is on) to permit operation of the one or more auxiliary elements. As should be appreciated, through selective operation of the first, second, and third power systems, the overall battery life of the power system may be increased, which may correspond to a longer period of operation of the power machine. Further, as noted above, the ability to selectively provide power to (and via) only some of the power systems can allow for more efficient configuration of the various parts.

In some exemplary embodiments, the power system may include a power allocation system. The power allocation system may be configured to allocate power from the power source to the first, second, or third power systems based on the operation of the telehandler. In some examples, the power allocation system may determine an amount of available power from the power source and subtract an amount of power equal to an amount of power used to operate the third power system (e.g., one or more auxiliary functions). Thus, the power allocation system may determine a remaining available power for use by the first and second power systems (e.g., the tractive and workgroup functions).

In some exemplary embodiments, the power allocation system may further determine a power allocation percentage for the first and second power systems (e.g., to determine how much of the remaining available power to supply to the first and second power systems). The power allocation system may determine the power allocation percentages based on which of the first or second power systems are currently active or based on a travel speed of the power machine (e.g., via reference to a look-up table). In some examples, the power allocation system may allocate a magnitude of power to the first (e.g., tractive) system and the second (e.g., workgroup) system based on the multiplication of the remaining available power by the power allocation percentage. In some examples, power allocated to, but not used by the first (e.g., tractive) system may be redistributed to the second (e.g., workgroup) system for use. Similarly, power allocated to, but not used by the second (e.g., workgroup) system may be redistributed to the first (e.g., tractive) system for use.

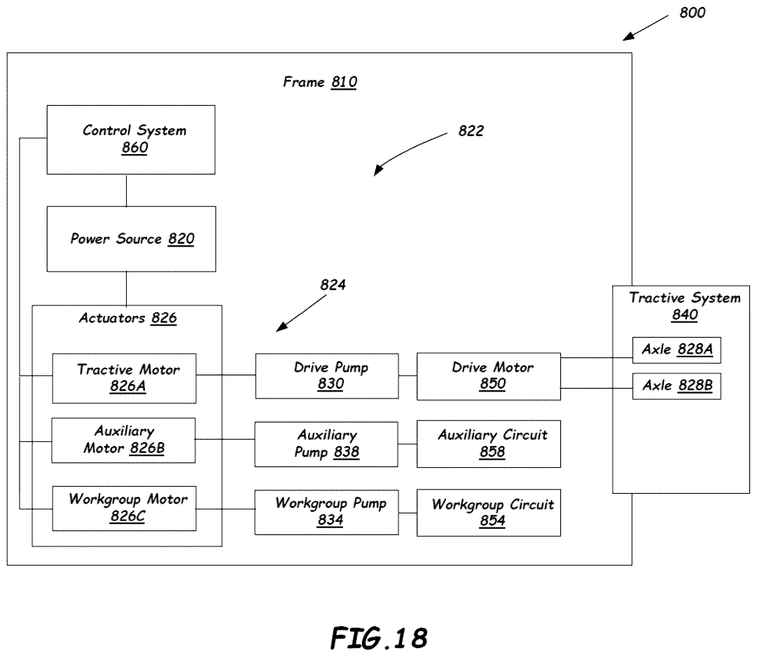

FIG. 18 illustrates an example of an electrically powered power machine 800, which is one particular example of the power machine 100 illustrated in FIG. 1. In one example, power machine 800 is a telehandler, as shown in FIG. 9. However, power machine 800 is not limited to telehandlers. Features of the power machine 800 described below include reference numbers that are generally similar to those used in FIG. 1. For example, the power machine 800 has a frame 810, just as power machine 100 has a frame 110. The power machine 800 should not be considered limiting especially as to the description of features that power machine 800 may have described herein that are not essential to the disclosed examples and thus may or may not be included in power machines other than the power machine 800 upon which the examples disclosed below may be advantageously practiced. Unless specifically noted otherwise, examples disclosed below can be practiced on a variety of power machines, with the power machine 800 being only one of those power machines. For example, some or all of the concepts discussed below can be practiced on many other types of work vehicles such as various other loaders, excavators, trenchers, and dozers, to name but a few examples.

The frame 810 of the power machine 800 supports a power system 822 that can generate or otherwise provide power for operating various functions on the power machine. In particular, the power system 822 can include an electric power source 820 configured to supply electric power for power machine operations (e.g., a battery assembly, a generator, a capacitor system, etc.), as well as a power conversion system 824 arranged to utilize the power from the power source 820 for useful power machine operations.

In particular, the power conversion system 824 of the power machine 800 can include various components, including mechanical transmissions, hydraulic systems, various motors or other actuators, and the like. In some examples, the power conversion system 824 of the power machine 800 includes one or more actuators 826 (e.g., electric motors 826A, 826B, 826C), which can be powered by the power source 820 and can be selectively controllable (e.g., via the control system 860) to provide a power to various work elements of the power machine 800. In some examples, as further discussed below, a tractive motor 826A can power a drive pump 830 (e.g., a hydrostatic drive pump), which may be connected to a drive motor 850 (e.g., a hydrostatic drive motor), which may provide power to axles 828A, 828B. Further, an auxiliary motor 826B can power an auxiliary pump 838 (e.g., a hydraulic pump) configured to provide pressurized hydraulic fluid to one or more auxiliary functions within an auxiliary circuit 858 of the power machine 800 (e.g., braking, steering, oil-cooling flow, pre-charge flow, etc.). Additionally, a workgroup motor 826C can power a workgroup pump 834 (e.g., a hydraulic pump) configured to provide pressurized hydraulic fluid to one or more work implements within a workgroup circuit 854 of the power machine 800 (e.g., hydraulic actuators to raise and lower a lift arm, extend or retract a telescoping boom, tilt an implement carrier, etc.).

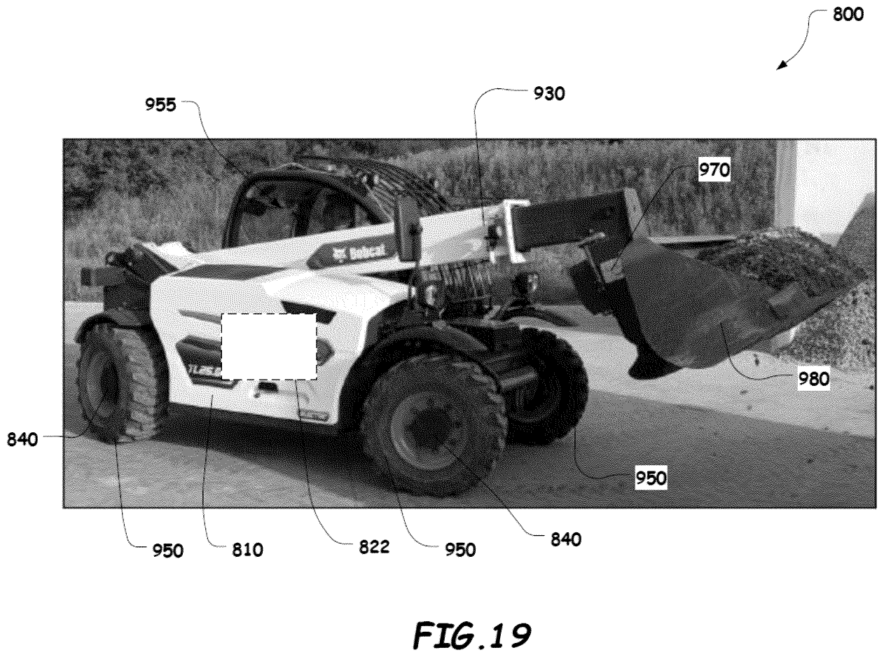

FIG. 19 illustrates an example of power machine 800 in the form of a telehandler, where the examples discussed below can be advantageously employed. To that end, features of the power machine 800 described below include reference numbers that are generally similar to those used in FIGS. 1 and 2. For example, the power machine 800 is described as having a frame 810, just as power machine 100 has a frame 110. However, the power machine 800 as illustrated should not be considered limiting, and examples disclosed below can also be practiced on a variety of other power machines.

The frame 810 of the power machine 800 supports a power system 822 that is capable of generating or otherwise providing power for operating various functions on the power machine. In particular the power system 822 can include an electric power source (e.g., a battery assembly, a capacitor assembly, a fuel cell, etc.) in some examples. Power system 822 is shown in block diagram form and is located within the frame 810.

The frame 810 also supports a work element in the form of a lift arm assembly 930 (e.g., including a telescoping boom) that is powered by the power system 822 and that can perform various work tasks. As the power machine 800 is a work vehicle, the frame 810 also supports the traction system 840, which is also powered by power system 822 and can propel the power machine over a support surface. The lift arm assembly 930 in turn supports an implement (e.g., accessory) interface 970 that can receive and secure various implements to the power machine 800 for performing various work tasks. In some examples, the implement interface 970 (or other sub-system) can include power couplers, to which an implement can be coupled to receive hydraulic or electric power from the power system 822.

The lift arm assembly 930 shown in FIG. 19 is one example of many different types of lift arm assemblies that can be attached to a power machine such as power machine 800 or other power machines on which examples of the present discussion can be practiced. The lift arm assembly 930 is moveable using actuators (e.g., hydraulic cylinders), to change position of the lift arm assembly 930 along a lift path with respect to the frame 810 (e.g., to raise and lower the lift arm assembly as desired). Other lift arm assemblies can have different geometries and can be coupled to the frame of a loader in various ways to provide lift paths. For example, some lift arm assemblies are configured to provide a vertical lift path, while others are configured to provide a radial lift path. Some lift arm assemblies can have an extendable or telescoping portion. Some power machines can have a plurality of lift arm assemblies attached to their frames, with each lift arm assembly being movable independent of the other(s). In one particular example, the lift arm assembly 930 of the power machine 800 may be offset (e.g., laterally offset) to one side of the power machine 800, with an operator station 955 arranged laterally from the lift arm assembly 930. Unless specifically stated otherwise, none of the inventive concepts set forth in this discussion are limited by the type or number of lift arm assemblies that are coupled to a particular power machine.

Some lift arms, including lift arms on excavators, may have portions that are controllable to pivot with respect to another segment instead of moving in concert (i.e., along a pre-determined path). Some power machines have lift arm assemblies with a single lift arm, such as is known in excavators, in some loaders, and in other power machines.

Generally, implements can be located forward of a front end of a frame of the power machine 800 (or at other locations), including implements that include or provide any suitable accessory for the power machine 800. For example, an implement 980 can be configured as a bucket (e.g., as shown), one or more forks, or a man lift, but is not so limited and may be nearly any variety of accessory that may be utilized and/or driven by the power machine 800. Generally, implements have a complementary machine interface that is configured to be engaged with the implement interface 970 in an operational configuration. Further, various implement power couplers can be included to provide hydraulic or electrical signals to or from an associated implement (e.g., the implement 980).

As mentioned above, the power machine 800 includes the operator station 955, from which an operator can manipulate various control devices to cause the power machine to perform various work functions. In some examples, the operator station 955 includes an operator seat and a plurality of operation input devices, including control levers and a steering wheel (e.g., control devices) that an operator can manipulate to control various machine functions, including as steering functions, drive functions, and auxiliary hydraulic functions (i.e., pressurized hydraulic flow made selectively available to an operably coupled implement). Operator input devices can include various human-machine interfaces including buttons, switches, levers, sliders, pedals, touchscreens, and the like that can be stand-alone devices such as hand-operated levers or foot-operated pedals, incorporated into hand grips, or incorporated into display panels, which may be included on a dashboard, including programmable input devices. Actuation of operator input devices can generate signals in the form of electrical signals, hydraulic signals, or mechanical signals. Signals generated in response to operator input devices are provided to various components on the power machine for controlling various functions on the power machine (e.g., to or via one or more electronic controllers of a larger electronic control system). Among the functions that can be controlled via operator input devices on power machine 800 include control of the traction system 840, the lift arm assembly 930, the implement interface 970, and providing signals to any implement that may be operably coupled to the implement.

Other power machines, including walk behind power machines may not have a cab nor an operator compartment, nor a seat. The operator position on such power machines is generally defined relative to a position where an operator can access and manipulate relevant operator input devices.

Various power machines that can include or interact with the examples discussed below can have various different frame components that support various work elements. The frame 810 discussed herein can include many elements, however the frame 810 is not the only type of frame that a power machine on which the disclosed technology can be practiced can employ. For example, the frame 810 of power machine 800 can include an undercarriage or lower portion of the frame 810 and a mainframe or upper portion of the frame 810 that is supported by the undercarriage. The main frame of power machine 800, in some examples is attached to the undercarriage such as with fasteners or by welding the undercarriage to the main frame. Alternatively, the main frame and undercarriage can be integrally formed. The frame 810 also supports a set of tractive elements in the form of wheels 950 at the front and back of both sides of the power machine 800.

The description of power machine 100 and power machine 800 above is provided for illustrative purposes, to provide illustrative environments on which the examples discussed below can be practiced. While the examples discussed can be practiced on a power machine such as is generally described by the power machine 100 shown in the block diagram of FIG. 1 and more particularly on the power machine 800, unless otherwise noted or recited, the concepts discussed below are not intended to be limited in their application to the environments specifically described above.

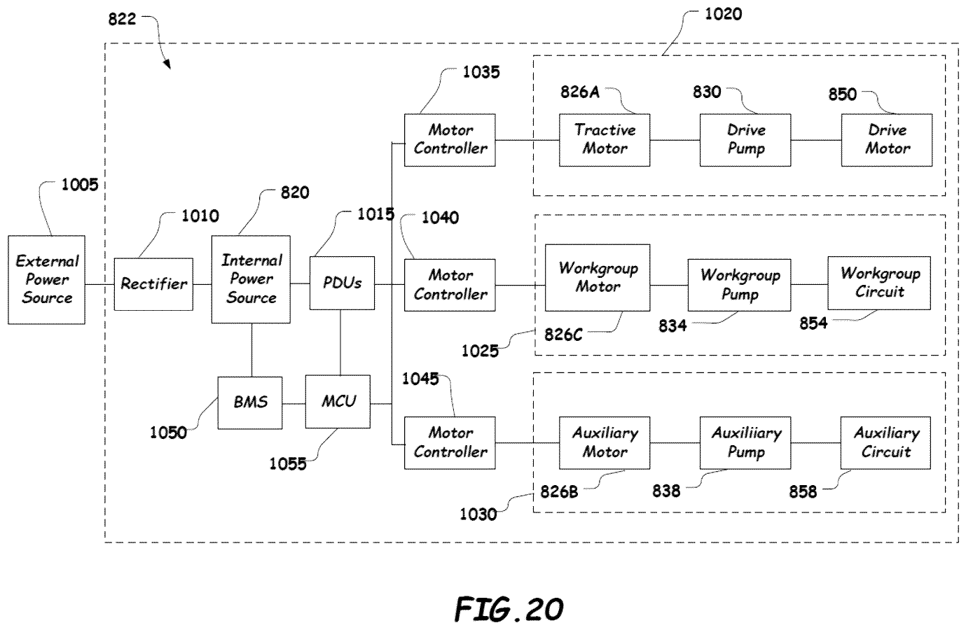

Turning now to FIG. 20, an example of the power system 822 of the power machine 800 is shown. As shown, the power system 822 may include one or more separate power systems, which may each be configured to power a particular set or subset of components of the power machine 800 (e.g., by converting or routing power from a common electrical power source). For example, the power system 822 may include a first power system 1020, a second power system 1025, and a third power system 1030. In some examples, the first power system 1020 may be configured to power one or more tractive elements of the power machine 800. For example, the first power system 1020 may include the tractive motor 826A, the drive pump 830, and the drive motor 850. In some examples, the second power system 1025 may be configured to power one or more workgroup elements of the power machine 800. For example, the second power system 1025 may include the workgroup motor 826C, the workgroup pump 834, and the workgroup circuit 854. In some examples, the third power system 1030 may be configured to power one or more auxiliary elements of the power machine 800. For example, the third power system 1030 may include the auxiliary motor 826B, the auxiliary pump 838, and the auxiliary circuit 858.

In some cases, each of the first power system 1020, the second power system 1025, and the third power system 1030 may be independent systems, i.e., may be selectively powered by the power source 820 (e.g., a battery system) independently from each other. Thus, the first, second, and third power systems 1020, 1025, 1030 may selectively (and independently) power the tractive elements, workgroup elements, or the auxiliary elements, respectively. In one particular example, the third power system 1030 may receive constant power from the power source 820 to facilitate consistent activation of the one or more auxiliary elements (e.g., a steering system, braking system, etc.). In contrast, the first and second power systems 1020, 1025 may selectively (e.g., intermittently) receive power from the power source 820 depending on the current operations of the power machine 800. For example, electric power may be routed to the power system 1020 only when travel commands are received, and electric power may be routed to the power system 1025 only when commands are received for operation of a lift arm or other workgroup element. Thus, due to the separation between the first power system 1020, the second power system 1025, and the third power system 1030, more efficient operation of the power machine 800 may be achieved, which may increase overall runtime of the power machine 800 (e.g., operation time of the power machine 800 without the need for charging of the power source 820).

In some examples, the first power system 1020 may be controlled by a motor controller 1035, the second power system 1025 may be controlled by a motor controller 1040, and the third power system 1030 may be controller by a motor controller 1045. For example, the motor controllers 1035, 1040, 1045 may be used to selectively operate the respective power systems 1020, 1025, 1030 based on power allocation from the power source 820. In some examples, power from the power source 820 may be allocated via one or more power distribution units (PDUs) 1015, which may be controlled via a machine control unit (MCU) 1055. In some examples, the MCU 1055 may distribute power to each of the motor controllers 1035, 1040, 1045 based on the operations of the power machine 800. For example, during travel of the power machine 800 over terrain, power may be distributed to the first power system 1020. However, if no workgroup element is being concurrently used, then power may not be distributed to the second power system 1025. As mentioned previously, power may be constantly distributed to the third power system 1030 whenever the power machine 800 is turned on. In some examples, rather than using the motor controllers 1035, 1040, 1045, only a single motor controller may be used to control each of the motors 826A, 826B, 826C or sub-combinations thereof. In some examples, in addition to the PDUs 1015, a battery management system (BMS) 1050 may be used to derate or otherwise determine available power from the power source 820, for example using the methods described above with reference to FIGS. 3-17. Further, the MCU 1055 may be used to allocate power to each of the first, second, and third power systems 1020, 1025, 1030, based on the available power determined by the BMS 1050.

Generally, the power source 820 may be an internal power source (i.e., internal to the power machine 800). For example, the power source 820 may be in the form of one or more batteries (e.g., rechargeable batteries) supported by a frame of the power machine 800 or other known electric power sources. In one particular example, the power source 820 may be in the form of a series of battery packs that together can supply 30 kWh of usable energy. The power source 820 may be recharged via connection between the power machine 800 and an external power source 1005 (e.g., via a charging cord, charging station, etc.). For example, the power machine 800 may include a charging socket to receive the charging cord. In some examples, the external power source 1005 may be an alternating current (AC) source and the internal power source 820 may be a direct current (DC) power source. Thus, a rectifier 1010 may be arranged upstream of the internal power source 820 to convert AC to DC.

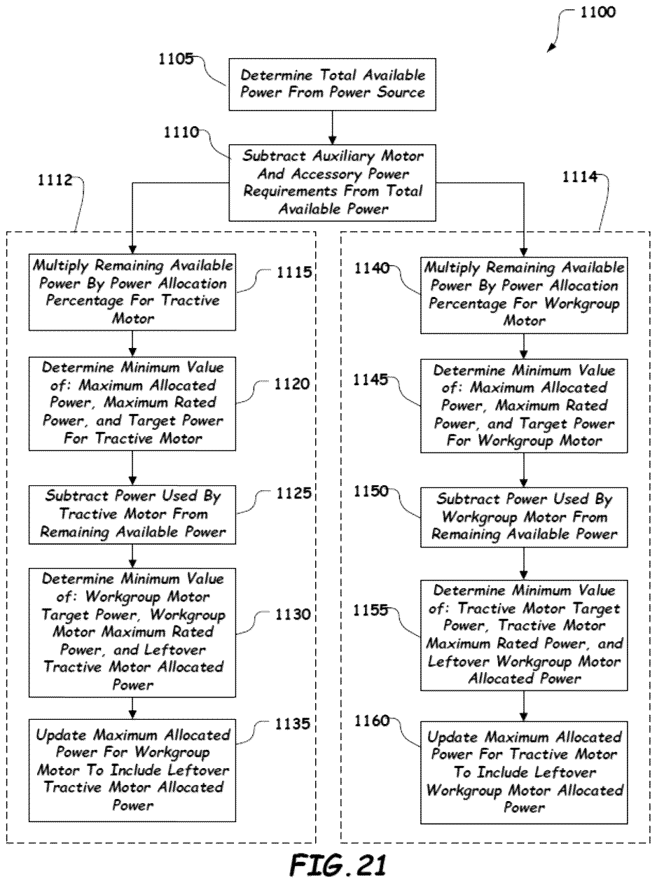

FIG. 21 shows an example of a power allocation method 1100 for use with the power system 822 (e.g., to allocate power to each of the power systems 1020, 1025, 1030). In some examples, the power allocation method 1100 may begin at stage 1105 by determining the total power available from the internal power source 820. For example, the one or more PDUs 1015 (e.g., each including one or more processors and a memory) may determine a nominal power of the internal power source 820. In some examples, the power from the power source 820 may be determined by the BMS 1050, which may determine the maximum or nominal power of the power source 820. For example, the BMS 1050 may determine (e.g., based on power or current values forming a power map or current map) whether to utilize the maximum power of the power source 820 (e.g., time-limited peak power) or the nominal power of the power source 820.

In one particular example, the power source 820 may be in the form of a series of battery packs that together can supply a continuous 30 kW of usable power and 49 kW of usable power for a predetermined period of time. For example, the battery packs may supply 49 KW of usable power for a time period of 10 seconds. In some examples, the time period may be longer or shorter depending on various characteristics of the battery pack. For example, a higher temperature of the battery pack, higher ambient temperature, or lower power demand may result in a shorter time period (e.g., less than 10 seconds). Correspondingly, a lower temperature of the battery pack, lower ambient temperature, or higher power demand may result in a longer time period (e.g., more than 10 seconds). In some examples, the BMS 1050 may limit (e.g., derate) the total power available from the internal power source to mitigate the risk of overheating, overcurrent events, etc. As should be appreciated, the power allocation method 1100 may be designed to reduce the risk of overheating or overcurrent events of the power source 820. Further, the power allocation method 1100 may be designed to maximize the efficiency of the power systems 1020, 1025, 1030 by permitting leftover allocated power from one power system to be used by another, different power system.

In some examples, at stage 1110, the power required to constantly (or presently) operate the auxiliary motor 826B may be subtracted from the total available power of the power source 820 (e.g., as determined at stage 1105). Thus, a remaining available power value may be calculated. As mentioned previously, the auxiliary motor 826B may be constantly running when the power machine 800 is turned on. Further, one or more accessory components (e.g., HVAC systems, 12 V plug(s), heaters, or other accessories) may be constantly or intermittently running when the power machine 800 is turned on. Accordingly, to ensure appropriate power management for other systems, it may be useful to subtract the power required to operate the auxiliary motor 826B, and the one or more accessory components, from the total available power to calculate the remaining available power that can be allocated to other systems (e.g., power remaining for operation of the tractive motor 826A and the workgroup motor 826C).

In some examples, following the determination of the remaining available power at stage 1110, the power allocation method 1100 may split into a tractive (e.g., first) motor allocation sub-method 1112 and a workgroup (e.g., second) motor allocation sub-method 1114. For the sake of brevity, the tractive motor allocation method 1112 will be discussed in detail below. However, it should be appreciated that the workgroup motor allocation method 1114 can be similar to the tractive motor allocation method 1112, in some examples, with the tractive (e.g., first) and the workgroup (e.g., second) motors swapped.

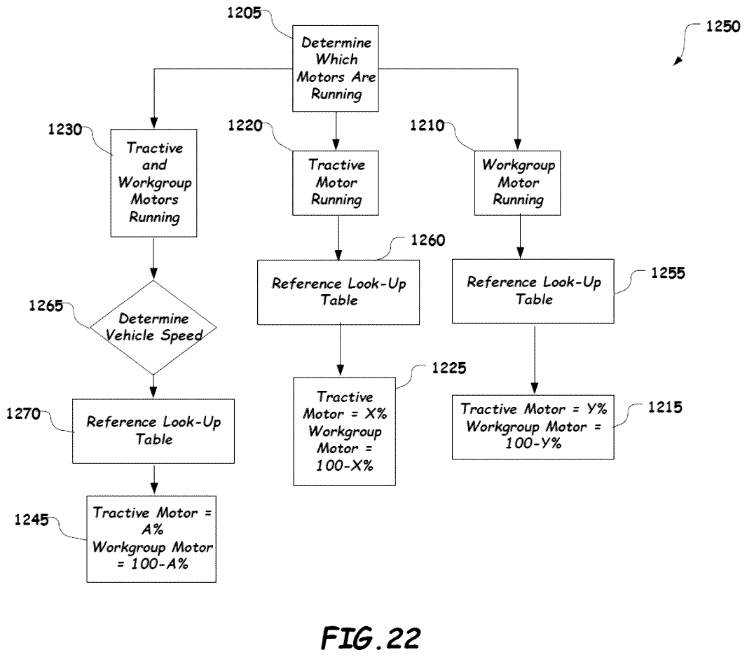

In some examples, in order to determine what percentages of the remaining available power to allocate to the tractive motor and the workgroup motor, respectively, the power allocation system 1100 may implement an additional sub-method 1250 (see, e.g., FIG. 22). For example, with reference to FIG. 22, at stage 1250, the MCU 1055 may determine if the tractive motor 826A, the workgroup motor 826C, or both are currently running.

In some examples, if the workgroup motor 826C is running, but the tractive motor 826A is not running (e.g., as shown at stage 1210), the tractive motor 826A may be allocated a certain percentage of the remaining available power, while the workgroup motor 826C may be allocated a remainder percentage of the remaining available power (see, e.g., stage 1215). However, in order to determine the power allocation percentages for the workgroup motor 826C and the tractive motor 826A, the power allocation system 1100 may reference a look-up table 1255, which may provide values for the power allocation between the tractive motor 826A and the workgroup motor 826C. Correspondingly, if the tractive motor 826A is running, but the workgroup motor 826C is not running (e.g., as shown at stage 1220), the tractive motor 826A may be allocated a certain percentage of the remaining available power, while the workgroup motor 826C may be allocated a remainder percentage of the remaining available power (see, e.g., stage 1225), based on the values referenced from the look-up table at stage 1260.

In some examples, if both the tractive motor 826A and the workgroup motor 826C are running (e.g., as shown at stage 1230), the MCU may determine the travel speed of the power machine 800 at stage 1265 and may allocate power between the motors 826A, 826C accordingly. For example, the MCU may reference a look-up table at stage 1270. In some examples, the look-up table may include predetermined power allocation values for both the tractive motor 826A and the workgroup motor 826C based on the travel speed of the power machine 800. For example, the look-up table may include a linear relationship between an increase in the travel speed of the power machine 800 and an increase in the power allocated to the tractive motor 826A. Thus, as the travel speed of the power machine 800 increases, the power allocated to the tractive motor 826A increases and, correspondingly, the power allocated to the workgroup motor 826C decreases.

With further reference to FIG. 21, once the power allocation percentages (e.g., discussed with regard to FIG. 22) is determined, as applicable, the respective power allocation percentages are multiplied by the remaining available power at stages 1115 (or 1140) to determine a maximum allocated power for the tractive motor 826A (or the workgroup motor 826C). Following this, at stage 1120, the MCU 1055 may determine the minimum value between the maximum allocated power (calculated at stage 1115), the maximum rated power of the relevant motor (e.g., of the tractive motor 826A), and the target power for the relevant motor (e.g., based on an operator command). In some examples, this determination may proceed in multiple stages (e.g., with a minimum determined first between target power and maximum rated power, and a minimum then determined between that first minimum and the maximum allocated power). Once the MCU 1055 has determined the minimum value at stage 1115, the MCU may distribute the minimum power value from stage 1220 to the tractive motor 826A for use by the tractive motor.

Further, at stage 1125, once the MCU 1055 distributes the power to the tractive motor 826A, the MCU may subtract the power used by the tractive motor (e.g., the power distributed to the tractive motor, corresponding to the minimum determined at stage 1220) from the remaining available power (e.g., as determined at stage 1110). In some examples, this value may be known as a tractive leftover power. At stage 1130, the MCU may determine the minimum value between the tractive leftover power (calculated at stage 1125), the maximum rated power (e.g., of the workgroup motor), and the target power for the workgroup motor (e.g., based on an operator-initiated command). Again, in some examples, this determination may proceed in multiple stages (e.g., with a minimum determined first between target power and maximum rated power, and a minimum then determined between that first minimum and the tractive leftover power). Once the MCU 1055 has determined the minimum value at stage 1130, the MCU may update a maximum allocated power for the workgroup motor 826C accordingly. For example, in some cases, the tractive motor 826A may not utilize all of the allocated power. Thus, this leftover power from the allocated tractive motor power may be available to be utilized by the workgroup motor 826C to increase power available for workgroup operations without negatively impacting tractive operations and thereby increase the efficiency and adaptability of the overall power system 822.

As mentioned previously, the workgroup motor allocation method 1114 may operate similarly to the tractive motor allocation method 1112 discussed above. However, the leftover power from the allocated workgroup motor power may instead be made available to be utilized by the tractive motor 826A (e.g., as based on a determination of updated maximum allocated power at stage 1160). As should be appreciated, the above power allocation method 1100 may be an iterative process, with the process occurring about once about every 10 milliseconds. In other examples, other time intervals for the iterative process may be used (e.g., about once every 20 milliseconds, 5 milliseconds, etc.)

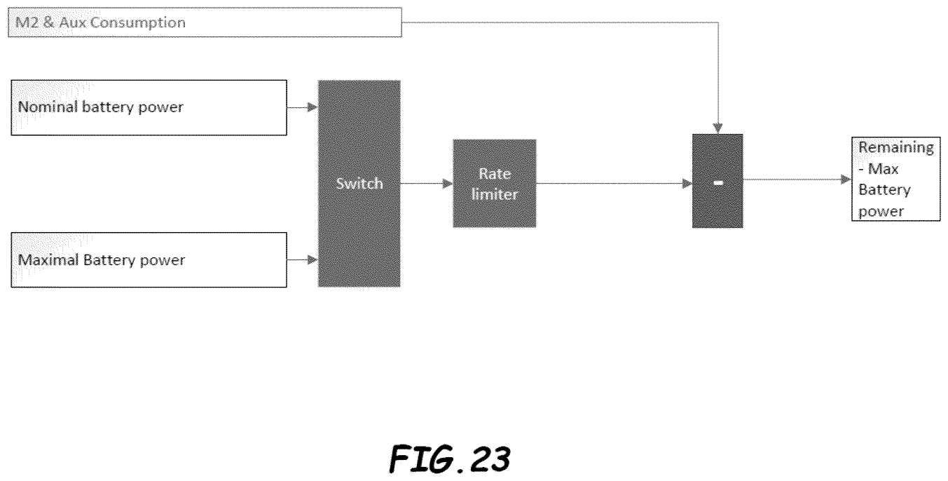

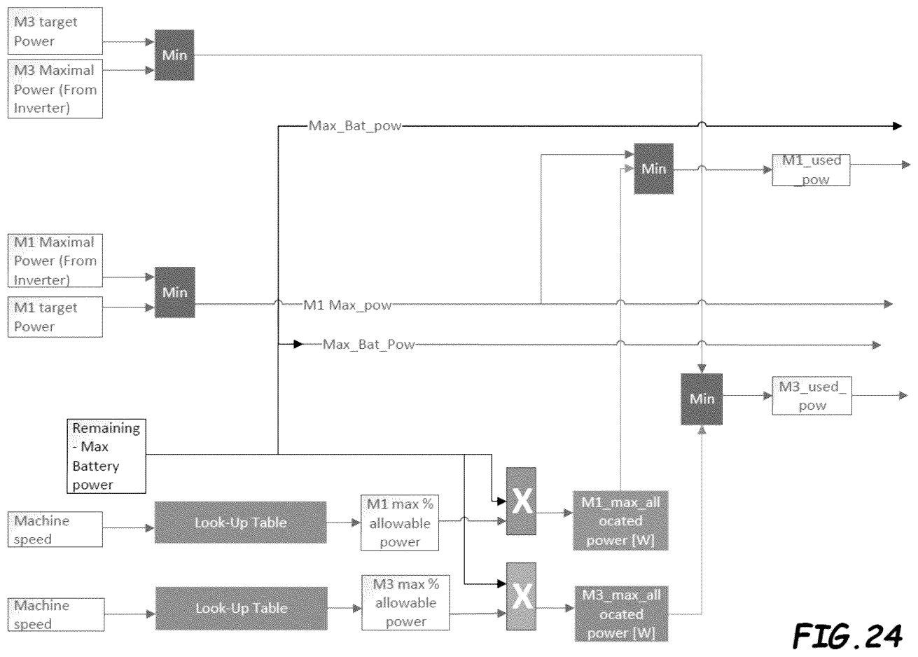

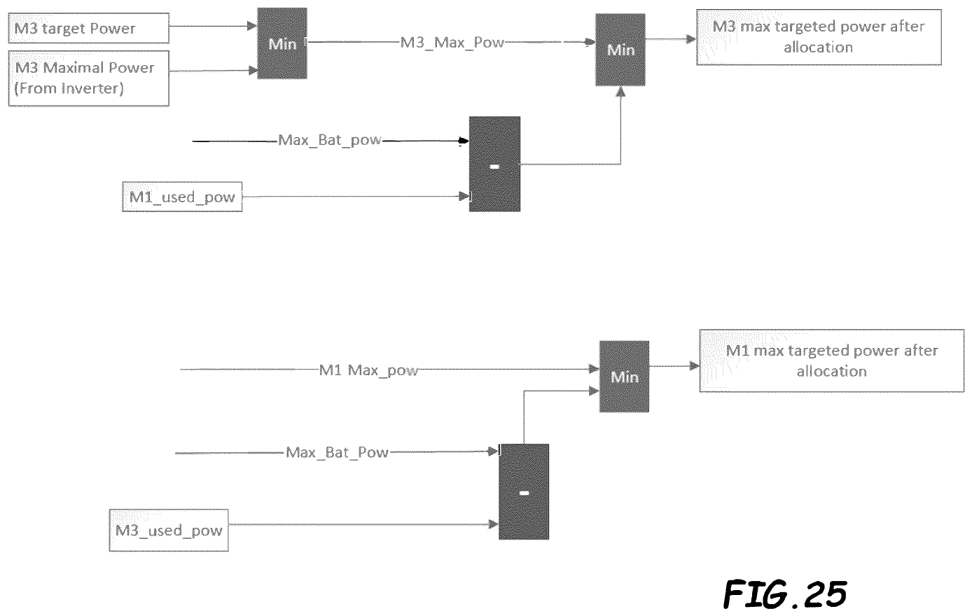

An example processing flow for an implementation of the methods 1100, 1250 is illustrated in FIGS. 23 through 25. In particular, in FIGS. 23 through 25, a tractive motor is indicated by M1, a workgroup motor is indicated by M3, and an auxiliary motor is indicated by M2. In other implementations, other configurations are possible.

In some implementations, devices or systems disclosed herein can be utilized or configured for operation using methods embodying aspects of the present disclosure. Correspondingly, description herein of particular features, capabilities, or intended purposes of a device or system is generally intended to inherently include disclosure of a method of using such features for the intended purposes, a method of implementing such capabilities, and a method of configuring disclosed (or otherwise known) components to support these purposes or capabilities. Similarly, unless otherwise indicated or limited, discussion herein of any method of manufacturing or using a particular device or system, including configuring the device or system for operation, is intended to inherently include disclosure, as examples of the disclosed technology, of the utilized features and implemented capabilities of such device or system.

Certain operations of methods according to the present disclosure, or of systems executing those methods, may be represented schematically in the figures or otherwise discussed herein. Unless otherwise specified or limited, representation in the figures of particular operations in particular spatial order may not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular implementations of the present disclosure. Further, in some examples, certain operations can be executed in parallel.

As used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

In some examples, aspects of the disclosed technology, including computerized implementations of methods according to the disclosed technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, aspects of the disclosed technology can be implemented as a set of instructions, tangibly embodied on a non-transitory computer-readable media, such that a processor device can implement the instructions based upon reading the instructions from the computer-readable media. Some examples of the disclosed technology can include (or utilize) a control device such as an automation device, a special purpose or general purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). In some examples, a control device can include a centralized hub controller that receives, processes and (re) transmits control signals and other data to and from other distributed control devices (e.g., an engine controller, an implement controller, a drive controller, etc.), including as part of a hub-and-spoke architecture or otherwise.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the disclosed technology, or of systems executing those methods, may be represented schematically in the FIGS., or otherwise discussed herein. Unless otherwise specified or limited, representation in the FIGS. of particular operations in particular spatial order may not necessarily require those operations to be executed in a particular sequence corresponding to the particular spatial order. Correspondingly, certain operations represented in the FIGS., or otherwise disclosed herein, can be executed in different orders than are expressly illustrated or described, as appropriate for particular examples of the disclosed technology. Further, in some examples, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” “block,” “stage,” “device,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

Also as used herein in the context of power machines, unless otherwise defined or limited, “tractive” or “drive” designate actuators and other work elements of a power machine that can be powered by a power source to cause movement of the power machine over terrain (e.g., wheeled or tracked ground-engaging elements, motors configured to power ground-engaging elements, and related assemblies). In contrast, “workgroup” is used to refer to actuators or other work elements of a power machine associated with powered operation of work elements that are not configured to provide powered travel over terrain (e.g., lift arm structures, attached implements, motors or other actuators to power movement of lift arm structures or attached implements, auxiliary power take-off interfaces, and related assemblies). Thus, tractive (or drive) actuators are arranged to power travel of a power machine whereas workgroup actuators are arranged to power non-travel work operations of the power machine. Correspondingly, discussion of workgroup functions refers to one or more functions provided by movement of one or more workgroup elements of a power machine, whereas discussion of tractive (or drive) functions refer to one or more functions provided for movement of the power machine itself over terrain.

Also as used herein, unless otherwise limited or defined, “operably supported” refers to two components that are moveably engaged together to transmit power. Similarly, “operably engaged” indicates that a first component and a second components are connected together so that the first component provides structural support to the second, relative to the first component or another structure.

Although the present invention has been described with reference to preferred embodiments, workers skilled in the art will recognize that changes may be made in form and detail without departing from the scope of the discussion.

What is claimed is:

1. A power machine comprising:
an electric power source including at least one battery providing a discharge current output and having a discharge current limit;
a priority system configured to receive power from the discharge current output of the at least one battery;
a non-priority system configured to receive power from the discharge current output of the at least one battery; and
a control system configured to determine, from the discharge current limit, a priority reserve of discharge current for the priority system, a non-priority reserve of discharge current for the non-priority system, and a pool of discharge current separate from the priority reserve and the non-priority reserve, the control system configured to control allocation of discharge current to the priority system and to the non-priority system as a function of the priority reserve, the non-priority reserve and the pool.

2. The power machine of claim 1, wherein the priority reserve is a first portion of the discharge current limit reserved solely for use by the priority system, wherein the non-priority reserve is a second portion of the discharge current limit reserved solely for use by the non-priority system, and wherein the pool is a remainder of the discharge current limit not included in the priority reserve and the non-priority reserve.

3. The power machine of claim 2, wherein the control system is further configured to determine a priority limit of discharge current for the priority system and a non-priority limit of discharge current for the non-priority system, wherein the control system controls allocation of discharge current to the priority system to allow the priority system to receive power from the discharge current output up to the priority limit, and wherein the control system controls allocation of discharge current to the non-priority system to allow the non-priority system to receive power from the discharge current output up to the non-priority limit.

4. The power machine of claim 3, wherein a combination of the priority limit and the non-priority limit exceeds the discharge current limit.

5. The power machine of claim 3, wherein a priority demand is determined by a sum of all instantaneous currents at a DC side of inverters of the priority system, and wherein a non-priority demand is determined by a sum of all instantaneous currents at a DC side of inverters of the non-priority system.

6. The power machine of claim 5, wherein the control system is configured to determine the priority limit of discharge current for the priority system using the relationship:
priority limit=Max(discharge current limit−Min(non-priority reserve,non-priority demand),priority reserve).

7. The power machine of claim 6, wherein the control system is configured to determine the non-priority limit of discharge current for the non-priority system using the relationship:
non-priority limit=Max(discharge current limit−priority demand,non-priority reserve).

8. The power machine of claim 2, wherein the control system is further configured such that when the pool of discharge current is determined to be zero, the priority reserve and non-priority reserve are scaled based upon a predetermined reserve ratio.

9. The power machine of claim 8, wherein the predetermined ratio is determined using the relationship:
reserve ratio=(discharge current limit)/(priority reserve+non-priority reserve);
wherein an adjusted priority reserve is determined using the relationship:
adjusted priority reserve=Min(priority reserve,priority reserve*reserve ratio); and
wherein an adjusted non-priority reserve is determined using the relationship:
adjusted non-priority reserve=Min(non-priority reserve,non-priority reserve*reserve ratio).

10. The power machine of claim 5, wherein the control system is further configured to derate power usage by the priority system as a function of inverter temperatures of inverters of the priority system and as a function of motor temperatures of motors of the priority system.

11. The power machine of claim 10, wherein the control system is configured to determine a temperature-based scalar for each inverter of the priority system and a temperature-based scalar for each motor of the priority system.

12. The power machine of claim 11, wherein the control system is configured to define an inverter temperature scalar as a minimum of all temperature-based scalars for all inverters of the priority system, wherein the control system is configured to define a motor temperature scalar as a minimum of all temperature-based scalars for all motors of the priority system, and wherein the control system is configured to determine a discharge current scalar, the control system further configured to define a power management scalar as a minimum of the inverter temperature scalar, the motor temperature scalar, and the discharge current scalar, the control system configured to derate the power usage by the priority system based upon the power management scalar.

13. The power machine of claim 12, wherein the discharge current scalar is defined by the control system as the priority limit divided by the priority demand.

14. The power machine of claim 12, wherein the control system is configured to derate the power usage by the priority system based upon the power management scalar by reducing one or more of discharge current provided to the priority system, torque of motors of the priority system, and speed of motors of the priority system.

15. The power machine of claim 12, wherein the control system is configured to define a second inverter temperature scalar as a minimum of all temperature-based scalars for all inverters of the non-priority system, wherein the control system is configured to define a second motor temperature scalar as a minimum of all temperature-based scalars for all motors of the non-priority system, and wherein the control system is configured to determine a second discharge current scalar, the control system further configured to define a second power management scalar as a minimum of the second inverter temperature scalar, the second motor temperature scalar, and the second discharge current scalar, the control system configured to derate the power usage by the non-priority system based upon the second power management scalar.

16. A power machine comprising:
an electric power source including at least one battery providing a discharge current output and having a discharge current limit;
a priority system configured to receive power from the discharge current output of the at least one battery, the priority system including at least one priority system inverter and at least one priority system motor;
a control system coupled to the electric power source and to the priority system, the control system configured to:
determine a temperature-based scalar for each inverter of the priority system;
determine a temperature-based scalar for each motor of the priority system;
determine an inverter temperature scalar as a minimum of all temperature-based scalars for all inverters of the priority system;
determine a motor temperature scalar as a minimum of all temperature-based scalars for all motors of the priority system;
determine a discharge current scalar for the priority system;
determine a power management scalar as a minimum of the inverter temperature scalar, the motor temperature scalar, and the discharge current scalar; and
the control system further configured to control at least one of the electric power source and the priority system to derate power usage by the priority system based upon the power management scalar.

17. The power machine of claim 16, wherein the control system is further configured to define a priority limit for the priority system, the priority limit being a maximum amount of the discharge current limit which the priority system is allowed to utilize, wherein the control system if further configured to identify a priority demand for the priority system, the priority demand being a sum of all instantaneous currents at a DC side of the priority system inverters, and wherein the control system is configured to determine the discharge current scalar for the priority system by dividing the priority limit by the priority demand.

18. The power machine of claim 17, and further comprising a non-priority system configured to receive power from the discharge current output of the at least one battery, the non-priority system including at least one non-priority system inverter and at least one non-priority system motor, wherein the control system is further configured to:
determine a temperature-based scalar for each inverter of the non-priority system;
determine a temperature-based scalar for each motor of the non-priority system;
determine a second inverter temperature scalar as a minimum of all temperature-based scalars for all inverters of the non-priority system;
determine a second motor temperature scalar as a minimum of all temperature-based scalars for all motors of the non-priority system;
determine a second discharge current scalar for the non-priority system;
determine a second power management scalar as a minimum of the second inverter temperature scalar, the second motor temperature scalar, and the second discharge current scalar; and
the control system further configured to control at least one of the electric power source and the non-priority system to derate power usage by the non-priority system based upon the second power management scalar.

19. A method of controlling power usage by a first system in a power machine having an electric power source including at least one battery providing a discharge current output and having a discharge current limit, the method comprising:
determining a temperature-based scalar for each inverter of the first system;
determining a temperature-based scalar for each motor of the first system;
determining an inverter temperature scalar as a minimum of all temperature-based scalars for all inverters of the first system;
determining a motor temperature scalar as a minimum of all temperature-based scalars for all motors of the first system;
determining a discharge current scalar for the first system;
determining a power management scalar as a minimum of the inverter temperature scalar, the motor temperature scalar, and the discharge current scalar; and
controlling at least one of the electric power source and the first system to derate power usage by the first system as a function of the power management scalar.

20. The method of claim 19, and further comprising:
determining a first limit for the first system, the first limit being a maximum amount of the discharge current limit which the first system is allowed to utilize;
determining a first demand for the first system, the first demand being a sum of all instantaneous currents at a DC side of the first system inverters; and
wherein determining the discharge current scalar for the first system comprises dividing the first limit by the first demand.
